(19) United States
(12) Patent Application Publication
(10) Pub. No.: US 2004/0186820 A1
(43) Pub. Date: Sep. 23, 2004

(54) Image display apparatus and program

(75) Inventors: Rieko Izume, Sakai-Shi (JP); Noriyuki Okisu, Osakasayama-Shi (JP); Motohiro Nakanishi, Kobe-Shi (JP); Takehisa Yamaguchi, Ikoma-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/462,154

(22) Filed: Jun. 16, 2003

(30) Foreign Application Priority Data
Mar. 20, 2003 (JP) P2003-078146

(51) Int. Cl. G06F 7/00

(52) U.S. Cl. 707/1

(57) ABSTRACT

The present invention provides an image display apparatus and a program by which the user can easily compare images with each other on the basis of a link between the images. An image display apparatus has a storing part in which an a group of images classified according to predetermined criteria are stored. For images included in the image group, link relations are defined. A reading part reads the images and the link relations from the storing part and outputs them to a display part and a layout determining part. The layout determining part determines a layout of images on a display of the display part on the basis of the link relations.

### BACKGROUND OF THE INVENTION

1. Field of the Invention

The present invention relates to an image display apparatus for displaying a plurality of images.

2. Description of the Background Art

In recent years, as the electronic technique develops, a digital camera for photographing a subject and generating a digital electronic image is used in a wider range. A digital electronic image captured by a digital camera has characteristics such that its display format is freely changeable and information other than a subject image can be freely added to the digital electronic image. A digital camera is therefore provided with various functions utilizing the characteristics. An example of such a digital camera has a guided image capturing function by which the user can capture an image with reference to a guide image as a sample of composition on a display provided in the digital camera.

Generally, in such guided image capturing, a plurality of guide images are prepared. For example, in the case where a second-hand car dealer captures an advertisement image of a second-hand car to be sold, it is desired to capture images of a car in a predetermined plural number of compositions (for example, front, sides, and rear). Consequently, a plurality of guide images as composition samples are prepared and the guided image capturing is performed.

In such guided image capturing, it is necessary to prevent correspondence between a captured image and a guide image from being erroneously recognized, so that it is desired to associate the captured image with the guide image. One of the means is, as suggested in Japanese Patent Application Laid-Open No. 2002-158953, to add a file name in which the guide image is reflected to the captured image.

In the conventional technique, the captured image and the guide image can be linked with each other and erroneous recognition of the correspondence can be prevented. However, a display method of the linked images is not considered. That is, although methods of capturing and recording images are considered, a method of displaying a recorded image is not considered. Consequently, it is almost impossible to easily compare images with each other on the basis of the link. Even if it is possible to compare images, complicated operations are required. For example, to compare images with each other on the basis of the link, very complicated operations have to be performed by using a computer system in which an image display program is installed or the like. The operations include the steps of (1) selecting linked images, (2) displaying the images in proper sizes, and (3) re-arranging the displayed images in a layout so as to be compared with each other. The present invention has been achieved to solve the problems and its object is to provide an image display apparatus and a program by which the user can easily compare images on the basis of the link between the images.

### SUMMARY OF THE INVENTION

An object of the present invention is to provide an image display apparatus and a program in which images can be easily compared with each other on the basis of a link between images.

In order to achieve the object, according to a first aspect of the present invention, an image display apparatus comprises: a storing part for storing an image group and information of a link relation, the image group being classified according to predetermined criteria, and the link relation defining the relation between a plurality of images included in the image group; a reading part for reading a group of linked images from the image group and the link relation, the link relation being defined for the group of linked images; a display part for displaying the group of linked images; and a layout determining part for determining a display layout of the group of linked images on the display part on the basis of the link relation.

In the image display apparatus, images to be compared with each other can be laid out and simultaneously displayed on the display part. Thus, the user can compare images to be compared with each other without a complicated operation and does not erroneously recognize the images to be compared.

According to a second aspect of the present invention, an image display apparatus comprises: a storing part for storing an image group and information of a link relation, the image group being classified according to predetermined criteria, and the link relation defining the relation between a plurality of images included in the image group; a reading part for reading a group of linked images from the image group and the link relation, the link relation being defined for the group of linked images; a display part for displaying the group of linked images; a dividing part for dividing an image display area into a plurality of areas, the image display area being provided in the display part; and a display position determining part for determining an area in which an image is to be displayed on the basis of the link relation, the image being an image included in the group of linked images and the area being one of the plurality of areas.

In the image display apparatus, images to be compared with each other can be laid out and simultaneously displayed on the display part. Thus, the user can compare images to be compared with each other without a complicated operation and does not erroneously recognize the images to be compared.

According to a third aspect of the present invention, there is provided a computer program product for causing a computer to execute processing including the following steps of: storing information of an image group and a link relation, the image group being classified according to predetermined criteria, and the link relation defining the relation between a plurality of images included in the image group; reading a group of linked images from the image group and the link relation, the link relation being defined for the group of linked images; displaying the group of linked images; and determining a display layout of the group of linked images on the display part on the basis of the link relation.

With the computer program product, images to be compared with each other can be laid out and simultaneously displayed on the display part. Thus, the user can compare images to be compared with each other without a complicated operation and does not erroneously recognize the images to be compared.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram for describing functions of a generalized image display apparatus 1;

FIG. 2 is a diagram showing a display screen of a display 131;

FIG. 3 is a diagram showing a display screen of the display 131;

FIG. 4 is a diagram showing a display screen of the display 131;

FIG. 5 is a perspective view when a digital camera 2 is seen diagonally from the front;

FIG. 6 is a rear view of the digital camera 2;

FIG. 7 is a functional block diagram showing the internal configuration of the digital camera 2;

FIG. 8 is a diagram showing a hierarchical structure of a folder in a memory card 209;

FIG. 9 is a diagram showing a link between images;

FIG. 10 is a diagram schematically showing the concrete contents of a tag;

FIG. 11 is a diagram showing a display screen of a liquid crystal monitor 211;

FIG. 12 is a diagram showing a display screen of the liquid crystal monitor 211;

FIG. 13 is a diagram showing a display screen of the liquid crystal monitor 211;

FIG. 14 is a diagram showing a display screen of the liquid crystal monitor 211;

FIG. 15 is a diagram showing a display screen of the liquid crystal monitor 211;

FIG. 16 is a diagram showing a display screen of the liquid crystal monitor 211;

FIG. 17 is a diagram showing a display screen of a liquid crystal monitor 211;

FIG. 18 is a diagram showing a display screen of the liquid crystal monitor 211;

FIG. 19 is a diagram showing a display screen of the liquid crystal monitor 211;

FIG. 20 is a diagram showing a display screen of a liquid crystal monitor 211;

FIG. 21 is a diagram showing a display screen of the liquid crystal monitor 211;

FIG. 22 is a diagram showing a display screen of the liquid crystal monitor 211;

FIG. 23 is a diagram showing a display screen of a liquid crystal monitor 211;

FIG. 24 is a diagram schematically showing a state where the display screen is switched;

FIG. 25 is a flowchart of defining an enlarged display screen group subroutine;

FIG. 26 is a flowchart of defining a folder-contents display screen group subroutine;

FIG. 27 is a flowchart of defining a comparison display screen group subroutine;

FIG. 28 is a flowchart of defining an index display screen subroutine;

FIG. 29 is a flowchart for describing a whole operation flow in a reproduction mode;

FIG. 30 is a diagram showing a display screen of the liquid crystal monitor 211;

FIG. 31 is a diagram showing a display screen of the liquid crystal monitor 211;

FIG. 32 is a flowchart for describing an operation flow in a new image capturing mode;

FIG. 33 is a diagram showing a display screen of the liquid crystal monitor 211;

FIG. 34 is a diagram showing a display screen of the liquid crystal monitor 211;

FIG. 35 is a diagram showing a display screen of the liquid crystal monitor 211;

FIG. 36 is a flowchart for describing operations in an additional image capturing mode;

FIG. 37 is a diagram for describing a method of switching an operation mode;

FIG. 38 is a flowchart for describing an operation of switching the operation mode;

FIG. 39 is a diagram showing a display screen of the liquid crystal monitor 211;

FIG. 40 is a diagram showing a display screen of the liquid crystal monitor 211; and

FIG. 41 is a diagram showing a display screen of the liquid crystal monitor 211.

### DESCRIPTION OF THE PREFERRED EMBODIMENTS

In a preferred embodiment of the present invention, first, main characteristic parts of an image display according to the preferred embodiment are generalized and described. After that, as a more concrete image display, an image display apparatus built in a digital camera will be described as an example.

Generalized Image Display Apparatus

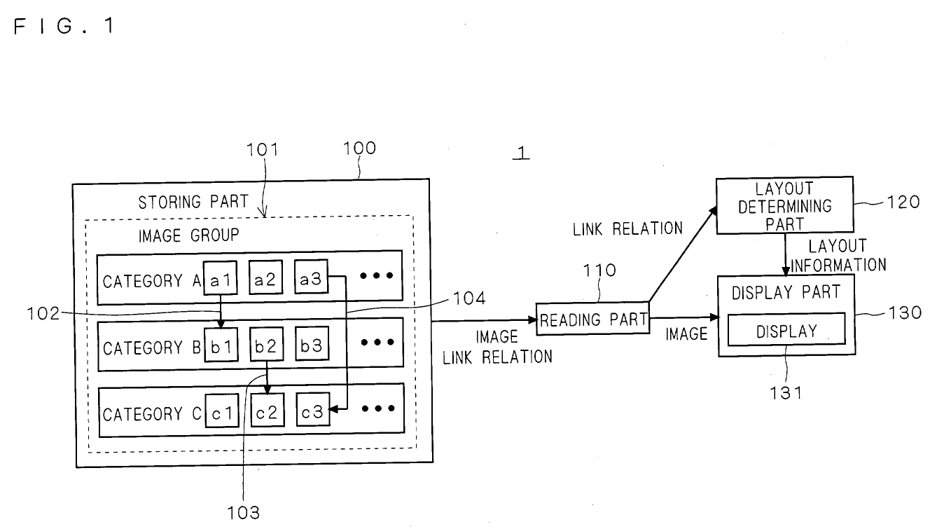

FIG. 1 is a block diagram for describing the functions of a generalized image display apparatus 1. In the following, the functions of the image display apparatus 1 will be described in sub blocks.

Storing Part

The image display apparatus 1 has a storing part 100 for storing a group 101 of images. In the storing part 100, the group 101 of images is stored by being classified according to predetermined criteria. FIG. 1 schematically shows that an image group a={a1, a2, a3, . . . }, an image group b={b1, b2, b3, . . . }, and an image group c={c1, c2, c3, . . . } are stored in the storing part 100 in a state where the groups a, b, and c are classified in categories A, B, and C, respectively. Various means can be considered as means for classifying the image groups. In a representative example, folders in a hierarchical folder (directory) structure are used as classifying means. In this case, a group of images stored in the same folder is regarded as a group of images belonging to the same category. Obviously, the classifying means can be arbitrarily changed according to a system for controlling storing means realizing the function of the storing part 100. The present invention defined by the appended claims is not limited to the classifying means.

Although the present invention is not also limited to the concrete criteria, for example, a mode of providing a folder for each group of images in a predetermined plural number of compositions, obtained by the guided image capturing in a digital camera can be considered. The mode considered is, more concretely, a mode of storing a group of images captured by photographing a plurality of second-hand cars to be sold in a second-hand car dealer in a predetermined plural number of compositions (for example, front, rear, and sides) so as to be classified to folders each created for each of the second-hand cars. In this case, images of different second-hand cars are stored into different folders. That is, the classifying means is folders and the criteria are second-hand cars.

Although the case where the number of categories is three is illustrated in FIG. 1, the number of categories may be two or less or four or more. The case where the number of categories is one is also included as a special case in the present invention.

Link Relation

Between images included in the group 101 of images, a link relation defining the relation between the images is provided “as necessary”. The link relation according to the preferred embodiment is a reference from a specific image α to another specific image β. In other words, a link from the image α to the image β. Further, in other words, definition of the link relation from the image α to the image β denotes that the image β is defined as an image related to the image α. In the following description, the link relation from the image α (link source) to the image β (link destination) will be expressed as a link L(α→β). “As necessary” means that a link relation is defined only for images which have to be linked. That is, it is unnecessary to define link relations for all of images. Concretely, a link relation is defined for only images desired to be viewed for comparison with each other and is not defined for the other images.

The link relation according to the preferred embodiment can be defined independently of the above-described categories. The present invention is not limited to the concrete examples of the link relation as well as the criteria. In the example of the second-hand car dealer, a link relation can be defined for images of almost the same composition regarding different second-hand cars. In other words, a link relation can be defined for images having almost the same composition stored in different folders. Such a link relation can be realized by a characteristic such that the link relation can be defined independently of the criteria.

In FIG. 1, a link L (a1→b1) from the image a1 to the image b1, a link L (b2→c2) from the image b2 to the image c2, and a link L (a3→c3) from the image a3 to the image c3 are schematically expressed as arrows 102, 103, and 104, respectively.

There are the following three methods of describing a link:

(1) a method of adding description to an image;

(2) a method of giving description apart from an image; and

(3) an intermediate method of (1) and (2).

The methods will be described later.

(1) Method of Adding Description to Image

This method is a method of adding information which can directly specify an image as a link destination to an image. An example of the information which can directly specify an image is a path and a file name of an image as a link destination in a hierarchical folder structure.- The method is suitably employed in an image display apparatus for displaying a small number of link images for the reason that it is sufficient to refer to a link relation added to the small number of images in order to specify a link relation, so that a process of specifying the link relation can be performed at high speed.

(2) Method of Giving Description Apart from Image

This method is a method of holding information, apart from images, which specifies a link relation of a group of images (for example, a data of a path and a file name of an image as a link source and an image as a link destination in a hierarchical holder structure) to which information specifying an image as a link destination is not added. This method is suitably employed in an image display apparatus for displaying a group of images having a number of link relations for the reason that since it is unnecessary to refer to a link relation for each image, the process of specifying a link relation can be performed at high speed. This method is also suitably applied to the case where link relations have regularity for the reason that it is unnecessary to add overlapped information to each of images. According to method, further, even when a link relation is changed, no influence is exerted on information added to an image. Consequently, the method is also suitably employed in the case where a link relation is changed frequently.

The present invention is not limited to the methods of writing link relations of the preferred embodiment. For example, the following link writing method can be employed. Specifically, when the path and file name of an image as a link source is X and the path and file name of an image as a link destination is Y, by writing a link relation in text as <link:from=“X” link:to=“Y”>, a link relation from an image as a link source to an image as a link destination can be written. That is, by writing the paths and file names of an image as a link source and an image as a link destination so as to be identified, the link relation can be written.

(3) Intermediate Method Between (1) and (2)

This method is a method of adding information which cannot perfectly specify an image as a link destination to an image and, in order to compensate the information, writing information which can specify the image as a link destination apart from an image as a link source. The method has an intermediate characteristic between the above two methods.

Any of the three methods (1) to (3) can be properly selected in accordance with the throughput of a computer used for processing an image, a program installed in a computer, and the characteristic of a link relation. Therefore, it is not disturbed to employ the writing method which has been described disadvantageous.

Reading Part

The image display apparatus 1 includes a reading part 110 capable of reading an image and a link relation from the storing part 100. The read image is outputted to a display part 130. The read link is outputted to a layout determining part 120.

Layout Determining Part

The layout determining part 120 determines a layout (placement, allocation, and so on) of an image on a display 131 provided in the display part 130 on the basis of the link relation inputted from the reading part 110. In other words, the layout determining part 120 determines a method of dividing an image display area in the display 131 into a plurality of regions of which number is larger than the number of images displayed and determines images displayed to the divided areas. The layout determined here is outputted as layout information to the display part 130.

Display Part

The display part 130 displays an image inputted from the reading part 110 so as to be visually recognized on the display 131. The display part 130 displays an image on the display 131 on the basis of the layout information inputted from the layout determining part 120.

Example of Layout (Basic Layout)

The layout of the image on the display 131 is determined on the basis of the link relation. A method of determining the layout of the image on the basis of the link relation will be described here with respect to the case of displaying images directly linked to each other by the link relation so as to be compared with each other (basic layout).

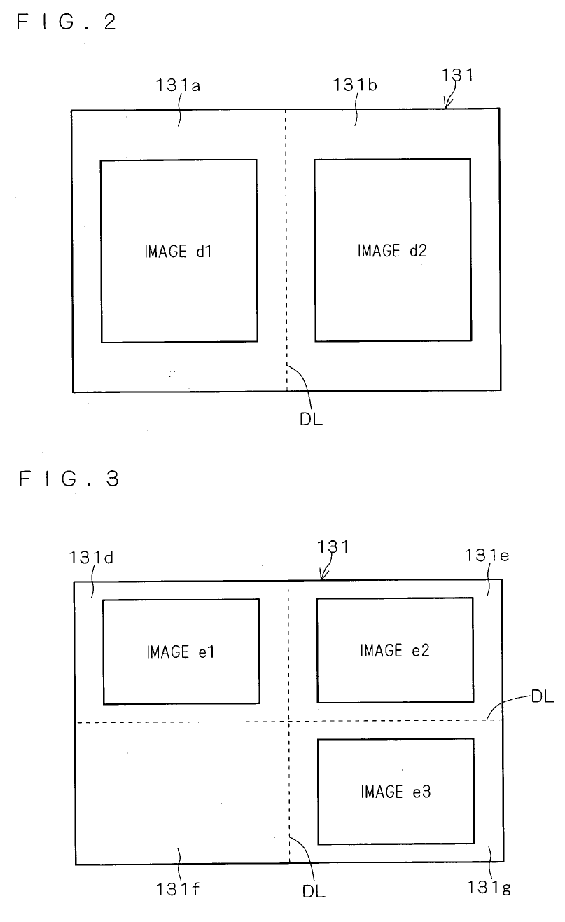

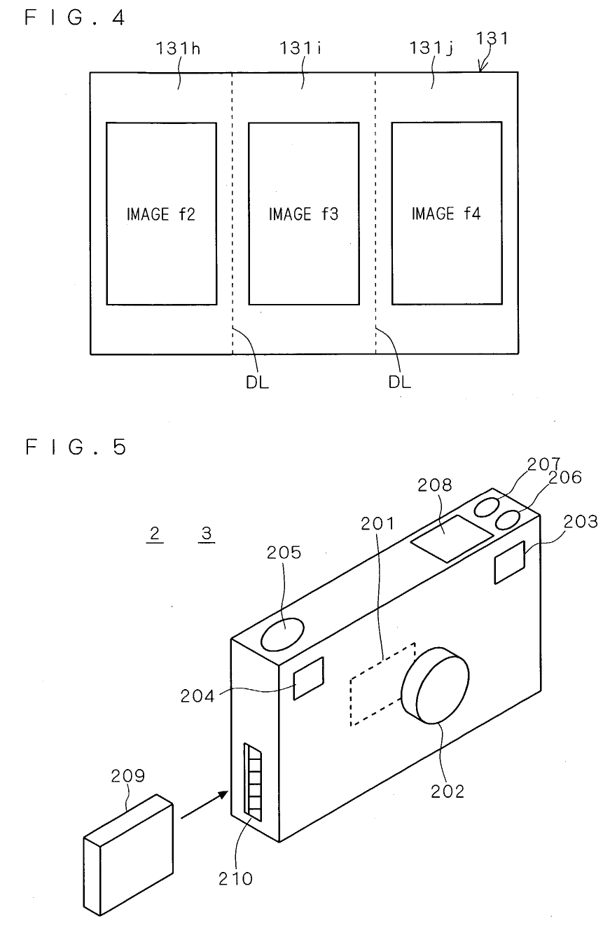

Images on the display 131 are displayed in the layout in which the images associated with each other by the link relation can be compared with each other. As an example of the layout, images d1 and d2 of which link relation L (d1→d2) is defined are arranged in the lateral direction of the rectangular display 131 (FIG. 2). In other words, a layout can be considered such that the image display area (in this case, the whole display 131) of the rectangular display 131 is divided into to areas 131a and 131b of a matrix of one row and two columns, and the images d1 and d2 are displayed in the areas 131a and 131b, respectively. A dotted line DL in FIG. 2 is drawn for convenience in order to clarify the boundary of the areas 131a and 131b and is not displayed in the actual display 131 (also in FIGS. 3 and 4).

In the layout, only the pair of images having the one link relation L (d1→d2) are simultaneously displayed on the display 131. As long as images can be compared with each other, a group of three or more images having a plurality of link relations are allowed to be simultaneously displayed on the display 131. For example, an image group e={e1, e2, e3} linked on the basis of a link relation L(e1→e2) and a link relation L(e1→e3) are allowed to be simultaneously displayed. When the number of images to be simultaneously displayed is two, erroneous recognition of the link relation between the images (a pair of images to be compared with each other) hardly occurs. However, in the case of simultaneously displaying a group of three or more images, to prevent erroneous recognition of a link relation, consideration is necessary for the layout. For example, as shown in FIG. 3, a layout in which the link source image e1 is disposed in the area of the left part of the display 131 and the link destination images e2 and e3 are disposed in the area of the right part of the display can be considered. In other words, a layout can be considered such that the image display area of the rectangular display 131 is divided into four areas 131d, 131e, 131f, and 131g in a matrix of two columns and two rows, and images e1, e2, and e3 are displayed in the areas 131d, 131e, and 131g, respectively, except for the lower left area 131f (in the second row and the first column). Since the image pair of which link relation is defined is displayed in different columns (positions in the lateral direction), the user of the image display apparatus 1 can recognize the link L(e1→e2) and the link L(e1→e3). That is, the images are laid out so that the images e1 and e2 can be compared with each other on the display 131 and the images e1 and e3 can be compared with each other. Obviously, the columns and rows can be interchanged with each other. The image display area may be divided into three or more portions in each of the vertical and lateral directions.

Example of Layout (Applied Layout)

An applied layout obtained by expanding the concept of “on the basis of link information” will be described. In the basic layout, images directly linked to each other on the basis of link relation are displayed simultaneously. In an applied layout, images which are not directly linked to each other by a single link relation but are indirectly associated with each other by a plurality of links are displayed simultaneously.

For example, an image group f={f1, f2, f3, f4} associated by link relations L(f1→f2), L(f1→f3), and L(f1→f4) will be considered. In this case, a partial image group f′={f2, f3, f4} of the image group f may be laid out on the display 131 and simultaneously displayed as shown in FIG. 4. In other words, when equivalent link relations are defined with respect to the partial image group f′, the partial image group f′ may be laid out and simultaneously displayed on the display 131. FIG. 4 shows a layout such that the image display area of the rectangular display 131 is divided into three areas 131h, 131i, and 131j in a matrix of one row and three columns and the images f2, f3, and f4 are displayed in the areas 131h, 131i, and 131j, respectively. The layout uses symmetry of the link relations L(f1→f2), L(f1→f3), and L(f1→f4). The above-described words “on the basis of the link L” include the case of using such symmetry of link relations.

Use of symmetry of link relations has some advantages. It is assumed that comparison between the images f1 and f2, comparison between the images f1 and f3, and comparison between the images f1 and f4 are desired and the link relations L(f1→f2), L(f1→f3), and L(f1→f4) are defined. In this case, the images f2, f3, and f4 are a group of images related to each other and it is often desired to display the images so as to be comparable with each other. However, when display “on the basis of the link relation” is interpreted in a narrow sense (basic layout) as display of a group of images associated directly by a link relation, the images f2, f3, and f4 cannot be displayed so as to be compared with each other. Alternately, link relations among the images f2, f3, and f4 have to be newly defined, and the link relations are complicated. However, by using symmetry of the link relations, without setting complicated link relations, images desired to be compared with each other can be displayed so as to be comparable.

Although the generalized image display apparatus 1 according to the preferred embodiment has been described above, an image display apparatus built in a digital camera will be described as an example in the following first and second preferred embodiments.

First Preferred Embodiment

In a first preferred embodiment, a digital camera for performing guided image capturing and reproducing and displaying an image captured by the guided image capturing will be described. With the digital camera of the first preferred embodiment, the user can perform the guided image capturing with reference to a guide image as a sample of photographing. The digital camera displays an image group so that images can be compared with each other on the basis of a link relation defined between a guide image and an image captured by the guided image capturing. In the following description, an example of reproducing and displaying an image group obtained by photographing a car with reference to the compositions of the guide image will be taken as occasion arises. However, this is an example and the use of the image display apparatus according to the present invention is not limited to such a use. Although the first preferred embodiment will be described with respect to a digital camera for performing guided image capturing and reproducing and displaying an image captured by the guided image capturing, the functions may be also realized as functions given to a general digital camera.

Configuration of Appearance of Digital Camera

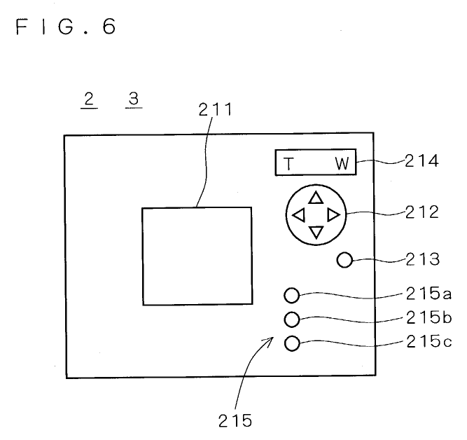

FIG. 5 is a perspective view showing a digital camera 2 of the first preferred embodiment obliquely from the front. FIG. 6 is a rear view of the digital camera 2.

As shown in FIG. 5, in the front face of the digital camera 2, a taking lens 202 for forming a subject image on a CCD (Charge Coupled Device) 201, a finder window 203 through which the user visually recognizes the subject, and a flash 204 are provided.

Further, in the top face of the digital camera 2, a release button 205 by which the user of the digital camera 2 instructs image capturing, a power switch 206 for sequentially switching the power between on and off, a mode switching button 207 for switching the operation mode of the digital camera 2, and a liquid crystal panel 208 for displaying image capturing parameters are provided.

Further, in a side face of the digital camera 2, an insertion port 210 into which a memory card 209 as a medium on which the guide image and the captured image are stored is inserted is provided.

As shown in FIG. 6, in the rear face of the digital camera 2, a liquid crystal monitor 211 as a rectangular display for displaying an image and the like, a cursor key 212 for moving the cursor displayed on the liquid crystal monitor 211 in four ways of up, down, right, and left, an execution button 213 for determining selection with the cursor key 212, a zoom key 214 for changing a zoom magnification of the taking lens 202, and a display setting button group 215 are provided. At the time of the image capturing, a live view is displayed on the liquid crystal monitor 211. At the time of reproduction, an image stored in the memory card 209 is reproduced and displayed on the liquid crystal monitor 211. The display setting button group 215 is constructed by a display switching button 215a, an enlarged display button 215b, and an index display button 215c. The button group is used for changing an image reproduction method on the liquid crystal monitor 211. The functions of the buttons will be described in detail in the description of “Reproduction Mode”.

Internal Configuration of Digital Camera

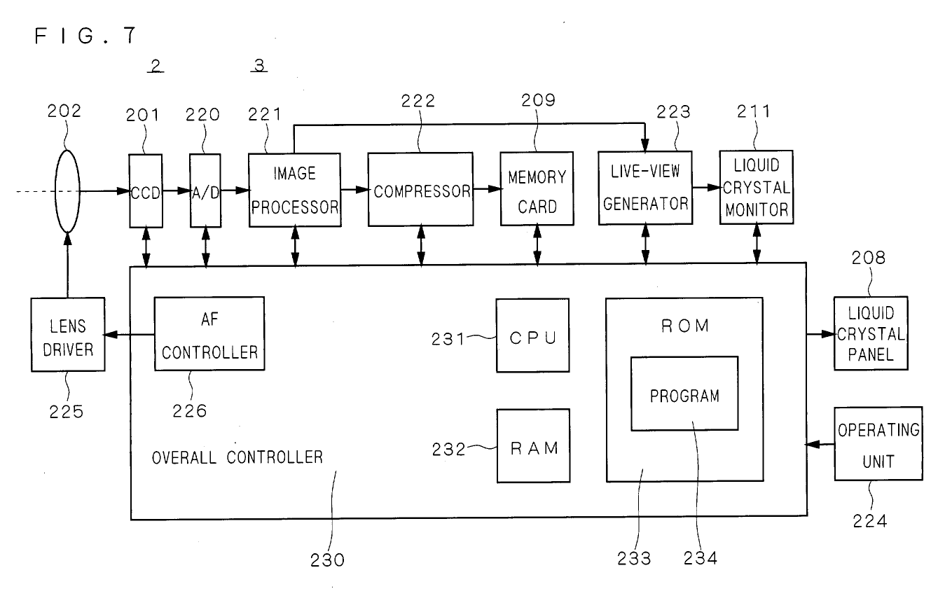

The internal configuration of the digital camera 2 will be described with reference to the functional block diagram of FIG. 7. 901 The digital camera 2 has the taking lens 202, CCD 201, A/D converter 220, and an image processor 221. A subject image obtained from the taking lens 202 is formed on the CCD 201. The CCD 201 converts the subject image to an image signal by a photoelectric converting action. The image signal is converted from an analog signal to a digital signal by the A/D converter 220. Further, the image signal is subjected to a predetermined imaging process in the image processor 221. The processed image signal is outputted as an image to a compressor 222, a live-view generator 223, and an overall controller 230. The live-view generator 223 generates a live view from the image. The live view is displayed on the liquid crystal monitor 211 while being updated at predetermined time intervals until the release button 205 is depressed in an image capturing standby mode. The compressor 222 converts the image inputted from the image processor 221 into an Exif (Exchangeable File Format) on depression of the release button 205 and stored into a predetermined folder in the memory card 209. At this time, in a tag of an image stored, a link is written. The details of the link and the folder in which the image is stored will be described later.

The digital camera 2 also has the liquid crystal panel 208 and an operating unit 224. On the liquid crystal panel 208, image capturing parameters of the digital camera 2 are displayed. The operating unit 224 includes the release button 205, power switch 206, mode switching button 207, cursor key 212, execution button 213, zoom key 214, and display setting button group 215 and functions as an interface for receiving an instruction of the user.

The digital camera 2 also has the overall controller 230 for controlling the above-described components in a centralized manner. The overall controller 230 is a microcomputer having a CPU 231, a RAM 232, and a ROM 233. In the ROM 233, a program 234 for specifying operations of the digital camera 2 is installed. By the program 234, image display in the reproduction mode which will be described later is realized. That is, the layout of an image in the reproduction mode is determined by the program 234.

The overall controller 230 has an AF controller 226 for outputting a control signal to a lens driver 225 for changing a focus state by driving the taking lens 202. The AF controller 226 drives the taking lens 202 so that the contrast in a partial area (AF area) of an image inputted from the image processor 221 becomes the maximum. In other words, the AF controller 226 performs an auto-focus control using the contrast. The partial area (AF area) of an image used for calculating contrast is written in the tag of the image at the time of storing the image to the memory card 209.

Registration of Guide Image

The digital camera 2 of the first preferred embodiment has to register a guide image as a sample of image capturing prior to the guided image capturing. In the following, a method of registering a guide image will be described.

In the memory card 209 of the digital camera 2, images (files) in the Exif are stored in a state where they are classified by folders in a hierarchical folder structure. The digital camera 2 recognizes, as a guide image, an image stored in a folder of a predetermined path and folder name in the hierarchical structure. The folder structure of the memory card 209 in which guide images are stored will be described first and, after that, a guide image registering method will be described.

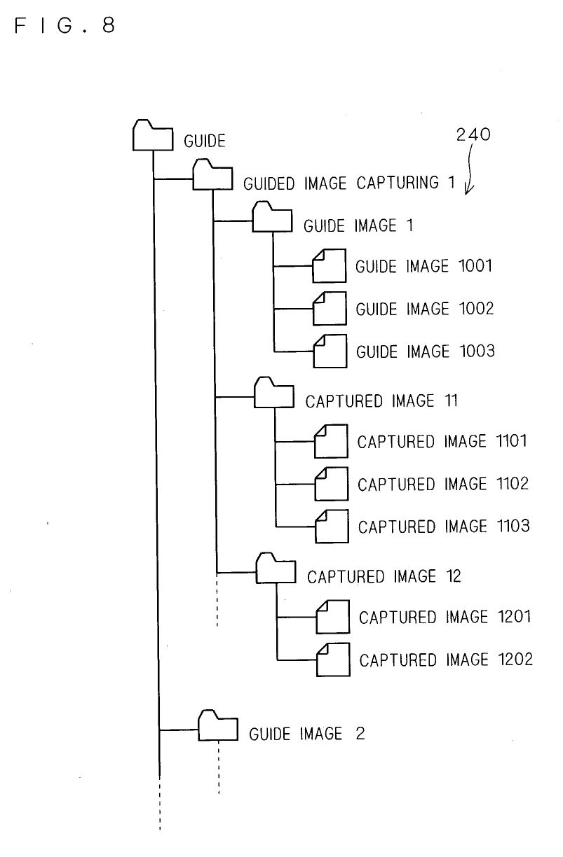

The folder structure of the memory card 209 will be described with reference to a folder tree 240 in FIG. 8. As shown in FIG. 8, as a folder in the uppermost layer of the folder tree 240 according to the guided image capturing, a “guide” folder is provided. In lower layers in the “guide” folder, guide images necessary for the guided image capturing and captured images obtained by the guided image capturing are stored in a predetermined folder structure.

In the lower layers of the “guide” folder in FIG. 8, two guided image capturing folders of a “guided image capturing 1” folder and a “guided image capturing 2” folder are provided. The guided image capturing folders are provided in correspondence with a series of guide images in a combination of a plurality of compositions. Therefore, the number of guided image capturing folders may be one or three or more. That is, guided image capturing folders only of the number of a series of guide images in a combination of a plurality of compositions are provided.

This will be described by taking, as an example, the case of performing the guided image capturing of a second-hand car in the description of the generalized image display apparatus 1. It is now assumed that the following three kinds of guided image capturing are performed by the digital camera 2 in the guided image capturing of a second-hand car.

(1) First guided image capturing of three images of the front, rear, and side.

(2) Second guided image capturing of five images of the front, rear, side, front seat, and rear seat.

(3) Third guided image capturing of six images of the front, rear, side, front seat, rear seat, and engine room.

In this case, as child folders of the “guide folder”, first to third guided image capturing folders according to the first to third guided image capturing respectively are provided. The number of folders can be arbitrarily increased or decreased in the permissible range of the storage capacity of the memory card 209 and computation ability of the overall computer 230.

Referring again to FIG. 8, description will be given. In lower layers of each guided image capturing folder, guided images and captured images are stored in a predetermined folder structure. The folder structures in guided image capturing folders are substantially the same. Therefore, in the following description, only the folder structure of lower layers of the “guided image capturing 1” folder will be described and detailed description of the other guided image capturing folders will not be given.

In a lower layer of the “guided image capturing 1” folder, as a child folder, a “guide image 1” folder in which guide images are stored is provided. The digital camera 2 recognizes an image stored in the “guide image 1” folder as a guide image of the guided image capturing according to the “guided image capturing 1” folder. In the case of FIG. 8, “guide image 1001”, “guide image 1002”, and “guide image 1003” stored in the “guide image 1” folder are recognized as guide images by the digital camera 2.

Generation of the “guide image 1” folder and registration of a guide image to the “guide image 1” folder are executed by, for example, performing a file operation on a computer system capable of read/write data from/to the memory card 209. Alternately, the digital camera 2 may be constructed so that such a file operation can be performed in the digital camera 2. A guide image stored in the guide image folder may be an image captured by the digital camera 2 or an image obtained by another means.

Captured Image Folder

In the same folder hierarchy as that of the guide image folder, a captured image folder in which an image captured by the guided image capturing is provided. One captured image folder is provided in correspondence with a series of guided image capturing in a combination of a plurality of compositions at the time of guided image capturing in a new image capturing mode which will be described later. Therefore, when a series of guide image capturing is performed a plurality of times, captured image folders of the same number are provided.

In the folder three 240 of FIG. 8, two captured image folders of a “captured image 11” folder and a “captured image 12” folder are generated in the same folder hierarchy as the “guide image 1” folder. In the “captured image 11” folder, three captured images (“captured image 1101”, “captured image 1102”, and “captured image 1103”) are stored. In the “captured image 12” folder, two captured images (“captured image 1201” and “captured image 1202”) are stored. In the “captured image 11” folder, all of captured images as link destinations of three guide images (“guide image 1001”, “guide image 1002”, and “guide image 1003”) are stored. In the “captured image 12” folder, only captured images as link destinations as a part of the three guide images are stored (it is assumed here that a captured image as a link destination of the “guided image 1003” is dropped out). Such a case happens when a series of guided image capturing is interrupted at some midpoint or a captured image is erased.

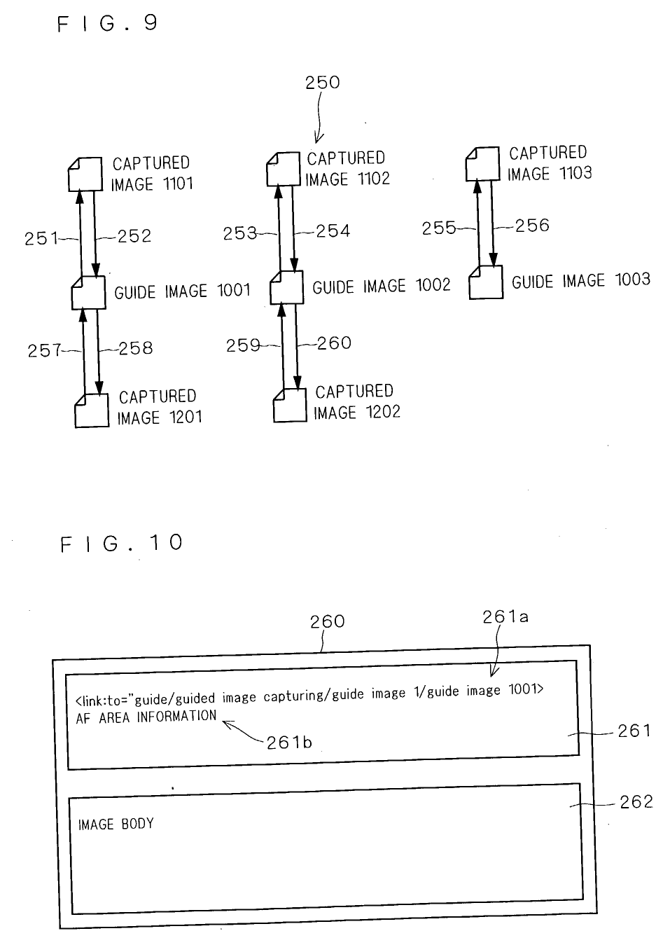

In the first preferred embodiment, the following description will be given on assumption that links expressed by arrows 251 to 260 are defined for images as shown in a link diagram 250 of FIG. 9.

Tag

To a folder, a tag in which information of the folder is written is added. To an image, a tag in which information of the image is written is added. A link defining the relation between images is written in the tag of the image. In the first preferred embodiment, the following link information (1) and (2) is written in a tag of an image.

(1) A path and a file name of a guide image used as a sample at the time of performing guided image capturing of a captured image, which are written in the tag of the captured image.

(2) A path and a file name of an image captured by using, as a sample, a guide image at the time of guided image capturing, which are written in the tag of the guide image.

The path may be written as a relative path or an absolute path. In the case of (1), the number of guide image in which the path and file name are written is one. In the case of (2), paths and file names of a plurality of captured images are allowed to be written. The digital camera 2 can specify a guide image as a link destination of a captured image by referring to (1). Concretely, when a captured image is designated, its tag is referred to, the path and the file name of a guide image as a link destination are read and the guide image as a link destination is specified. Similarly, by referring to (2), the captured image to which the guide image is linked can be also specified. The link is written in the tag of an image when the image is captured by the guided image capturing in the new image capturing mode and an additional image capturing mode. The writing operation is performed in a new capturing mode and an additional image capturing which will be described later.

In this example, the link between images is bidirectional. When a link L (U→V) exists between images U and V, a link L (V→U) also exists. However, the link does not have to be always bidirectional. Only one direction may exist. For example, when the images U and V has a clear relation of master and servant, a reference is made only to the image V as a link destination on the basis of the image U, and a reference to an image in the opposite direction is unnecessary, only the link L (U→V) is defined and the link L (V→U) may be omitted. In this case, however, the image U cannot be referred to from the image V.

The method of writing links corresponds to the “method of adding information of a link to an image” described on the generalized image display apparatus 1. Obviously, a text of the link relation may be held as a file separated from an image.

An example of writing a tag will be described with reference to FIG. 10. FIG. 10 schematically shows concrete contents of a tag of the “captured image 1101”. In a file 260 of the “captured image 1101”, a tag 261 and an image body 262 are included.

The image body 262 is information written in a predetermined format of an image. The image body 262 includes image information of high resolution. In the tag 261, various information including a thumbnail image obtained by reducing the size of an image is written. Important information for realizing the functions of the image display apparatus according to the preferred embodiment includes link destination information 261a and AF area information 261b. In the digital camera 2 according to the first preferred embodiment, a thumbnail image is displayed on the liquid crystal monitor 211. Obviously, when computation ability of the overall controller 230 and the display ability of the liquid crystal monitor 211 are at levels at which a high-resolution image can be displayed, a high-resolution image may be displayed on the liquid crystal monitor 211.

The link destination information 261a is a path and a file name of a link destination information (“guide image 1001”) written in a predetermined format. In this case, the path and the file name of a link destination image are expressed by “guide/guided image capturing/guide image 1/guide image 1001” and an absolute path (folder name and file name are detailed while being set apart by a symbol “/” from an upper layer to a lower layer), and the link destination information is written as <link:to=“guide/guided image capturing/guide image1/guide image 1001”>. Since the link source is local, the link source is omitted in this expression. Obviously, the method of expressing a path is arbitrary and various known expressing methods can be applied.

The AF area information 261b is information for specifying an area used by the AF controller to evaluate a focus state of the taking lens 202 and is concretely expressed by pixel coordinates or the like. The information is information for specifying, so to speak, a “focus” point.

Although the information regarding a link relation written in a tag has been described, information other than a link between images, specifically, the relation between a folder and an image and the relation between folders is also written in the tag and used for image display. Concretely, the following information (3) to (5) is written in a tag.

(3) A path and a folder name of a guide image folder corresponding to a captured image folder, written in the tag of the captured image folder (the guide image folder to be written is only one).

(4) A path and a folder name of a captured image folder corresponding to a guide image folder, written in the tag of the guide image folder (a plurality of captured image folders are allowed to be written).

(5) Pointers to a parent folder, a child folder, and child image data in a hierarchical folder structure, written in a tag of each folder and each image. In other words, in a tag of each folder, pointers to a parent folder, a child folder, and child image data are included. In a tag of each image file as an end element of the hierarchical folder structure, a pointer to a parent folder is included. For example, in the tag of the “guide image 1” folder, the pointer to the “guided image capturing 1” folder as a parent folder and pointers to three images as child image data (“guide image 1001”, “guide image 1002”, and “guide image 1003”) are included. In the “guide image 1001”, the pointer to the “guide image 1” as a parent folder is included. In this case, the pointer to the parent folder is only one. However, with respect to the pointer to a child folder or child image data, a plurality of pointers are allowed to be written.

Operation Mode of Digital Camera

The operation of the digital camera 2 will be described later. The digital camera 2 has two image capturing modes of a new image capturing mode and an additional image capturing mode and one reproduction mode. The operation modes can be switched by depressing the mode switching button 207. In the following, the operation of the digital camera 2 in each of the operation modes will be described and, after that, a method of switching the three operation modes will be described.

Reproduction Mode

In the following, the reproduction mode of the digital camera 2 will be described. In the reproduction mode, images stored in the guide image folder and the captured image folder as a child folder of a selected guided image capturing folder are displayed in various layouts on the liquid crystal monitor 211. As display screens, eight kinds of display screens to be described later exist. The display screen of the eight kinds can be classified into the following four groups (A) to (D) in accordance with the characteristics.

(A) List Display Screen Group

A display screen displaying a list of a number of images on the liquid crystal monitor 211. In the display screen of the list display screen group, a specific guide image or captured image may be selected and transfer to another display screen. That is, the display screen in the list display screen group has the function of an index.

(B) Folder-contents Display Screen Group

A display screen suitable for comparison among captured images stored in a selected captured image folder. In the example of guided image capturing of a second-hand car, the group includes a display screen on which images in various compositions of a specific car can be compared with each other.

(C) Comparison Display Screen Group

A display screen suitable for comparison among link images stored in a plurality of child folders in a selected guided image capturing folder. That is, a display screen on which images stored in different folders but associated with each other by a link relation can be compared with each other. In the example of the guided image capturing of a car, a display format in which images of almost the same composition of a plurality of cars can be compared each other.

(D) Enlarged Display Screen Group

A display screen on which a specific captured image is enlarged to an entire image display area of the liquid crystal monitor 211 and displayed. The enlarged display screen group is suitable to view the details of a specific captured image.

In the following, the eight kinds of display screens will be described in each of the groups (A) to (D).

(A) List Display Screen Group

The list display screen group includes a “default display screen” and an “index display screen”. The captured image folder of a captured image displayed on the display screen is a selected specific captured image folder or an all-captured-image folder.

Default Display Screen

“Default display screen” is a display screen on which all of images stored in a selected captured image folder (for example, “captured image 11” folder) and the guide image folder (“guide image 1” folder) corresponding to the selected captured image folder are displayed.

In a “default display screen” 270 shown in FIG. 1, an image is displayed in each of areas R11 to R16 obtained by dividing an image display area R1 of the liquid crystal monitor 211 into a matrix of two rows and three columns. The three images in the first row (areas R11 to R13) are three guide images (“guide image 1001”, “guide image 1002”, and “guide image 1003” from the left) stored in the “guide image 1” folder. Three images in the second row (areas R14 to R16) are three captured images (“captured image 1101”, “captured image 1102”, and “captured image 1103” from the left) stored in the “captured image 11” folder. In such a layout, a group of images displayed in the same column (for example, the areas R11 and R14) are a linked image group. Specifically, a group of linked images are laid out in the vertical direction of the liquid crystal monitor 211. Three arrays in the vertical direction corresponding to three equivalent (symmetrical) link relations are further laid out in the lateral direction of the liquid crystal monitor 211. Specifically, images in the vertical direction are arranged according to the “basic layout” described with respect to the generalized image display apparatus 1. Images in the lateral direction are arranged on the basis of the “applied layout” described with respect to the generalized image display apparatus 1.

Although a reference of the sequence in the lateral direction is not particularly limited, the sequence of images defined by information (serial numbers or the like) included in file names, date and time of photographing, or the like can be employed (hereinafter, unless the sequence of images are otherwise specified, such an order is employed as the reference of the sequence). The dotted line DL in FIG. 11 is drawn for convenience in order to easily grasp the image display areas and is not shown in the actual liquid crystal monitor 211 (also in the following drawings).

The “default display screen” 270 will be more concretely described by using the case of a car at the beginning of the description. The first row has guide images captured by photographing a car in different compositions. The second row has captured images which are captured by photographing another car in different compositions. The six images are laid out so that two images in each column become images of the two images in similar compositions. By such a display method, even when a number of images are simultaneously displayed, the user can easily grasp images to be compared with each other. Since such displaying operation is automatically performed, the user does not have to perform complicated operations, and erroneous recognition of images to be displayed does not occur so much.

On the liquid crystal monitor 211, in addition to the images, a character sequence M1 indicative of guide images and a character sequence M2 describing the folder name in which images are stored are also displayed. By the display, erroneous recognition of images displayed can be prevented with reliability.

On one of the images displayed, a cursor KR is superimposed. The user can move the position of the cursor KR by using the cursor key 212 (also in the following drawings).

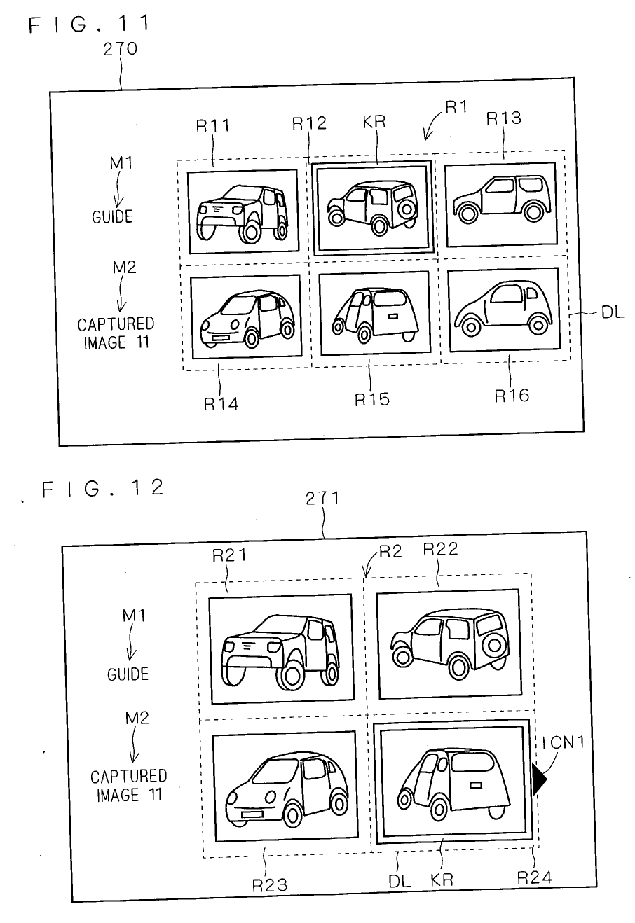

FIGS. 12 and 13 show a modification of the “default display screen” 270 illustrated in FIG. 11. “Default display screens” 271 and 272 of FIGS. 12 and 13 correspond to screen in which the number of images arranged in the lateral direction of the “default display screen” 270 are reduced from three to two (the matrix is changed from two rows and three columns to two rows and two columns) and each of images displayed is enlarged. In this case (generally, the case where the number of columns is smaller than the number of guide images), the three images stored in each of the “guide image 1” folder and the “captured image 11 folder” cannot be simultaneously displayed, so that it is necessary to change an image displayed by a scroll operation by the cursor key 212. Specifically, the following images have to be displayed while being switched by the scroll operation.

(1) The “default display screen” 271 in which “guide image 1001”, “guide image 1002”, “captured image 1101”, and “captured image 1102” are displayed in areas R21, R22, R23, and R24, respectively.

(2) The “default display screen” 272 in which “guide image 1002”, “guide image 1003”, “captured image 1102”, and “captured image 1103” are displayed in areas R31, R32, R33, and R34, respectively.

On the right side of the “captured image 1102” in the “default display screen” 271, an icon ICN1 of the right-pointing arrow indicative of the existence of not-shown “captured image 1103” is displayed. On the left side of the “captured image 1102” in the “default display screen” 272, an icon ICN2 of the left-pointing arrow indicative of the existence of not-shown “captured image 1101” is displayed.

In the case where the icon ICN1 is displayed on the liquid crystal monitor 211, when the cursor key 212 is operated to move the cursor KR onto the “captured image 1102” on the right side of which the icon ICN1 is displayed and to move the cursor KR further to the right, the screen displayed on the liquid crystal monitor 211 changes from the “default display screen” 271 to the “default display screen” 272. On the contrary, in the case where the icon ICN2 is displayed on the liquid crystal monitor 211, when the cursor key 212 is operated to move the cursor KR onto the “captured image 1102” on the left side of which the icon ICN2 is displayed and to move the cursor KR further to the left, the screen displayed on the liquid crystal monitor 211 changes from the “default display screen” 272 to the “default display screen” 271. By employing such a display switching method, the “default display screen” 270 virtually exists. A visual effect equivalent to that in the case of enlarging a part of a virtual screen and displaying the resultant screen onto the liquid crystal monitor 211 can be produced. It enables an image to be more largely displayed while preventing erroneous recognition of an image and a link, so that the details of an image can be viewed easier. Further, by displaying the icons ICN1 or ICN2 indicative of a scrollable direction on the liquid crystal monitor 211, the user can easily recognize the scrollable direction, so that the cursor operation for displaying a desired image can be known.

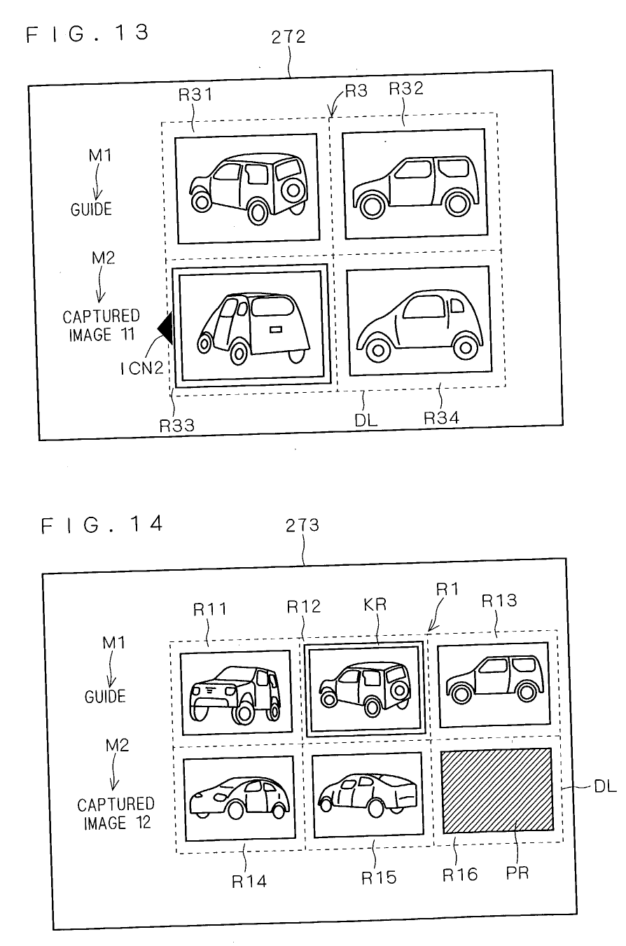

In the above description, all of images to which three guide images are linked are included in the selected “captured image 11” folder. However, in the case where the selected folder is the “captured image 12” folder, there is no image as a link destination of a guide image (“guide image 1003”). In this case, there is no image to be displayed in the second row and in the third column (area R16) in the “default display screen” 271. In such a case, as shown in the “default display screen” 273 in FIG. 14, the digital camera 2 generates an alternative image PR indicative of absence of an image to be displayed and displays it in the area (hatched in the diagram). The alternative image PR may be arbitrary and a uniform gray screen, a message indicative of absence of an image to be displayed (such as “no link image”), or the like can be employed. The alternative image PR is also displayed in the case where there is no image as a link destination to be displayed in the following display screen.

By displaying such an alternative image PR, the user can easily recognize that there is no image as a link destination. Therefore, the user can easily notice that photographing is forgotten or an image is erased by mistake.

The above-described display of images can be realized by the image display apparatus built in the digital camera 2 according to the first preferred embodiment, which lays out images on the basis of a link relation. Specifically, a digital camera in which a conventional image display apparatus for simply displaying a plurality of images in a selected folder cannot perform such a display method. To realize the display method, the user has to perform a complicated operation of displaying images to be compared and arranging the images while checking the relation between the images displayed one by one.

Index Display Screen

An “index display screen” 280 is a display screen in which all of images stored in all of captured image folders (“captured image 11” folder and “captured image 12” folder) and guide image folders (“guide image 1” folder)” as child folders of a selected guided image capturing folder (for example, “guided image capturing 1” folder) are displayed.

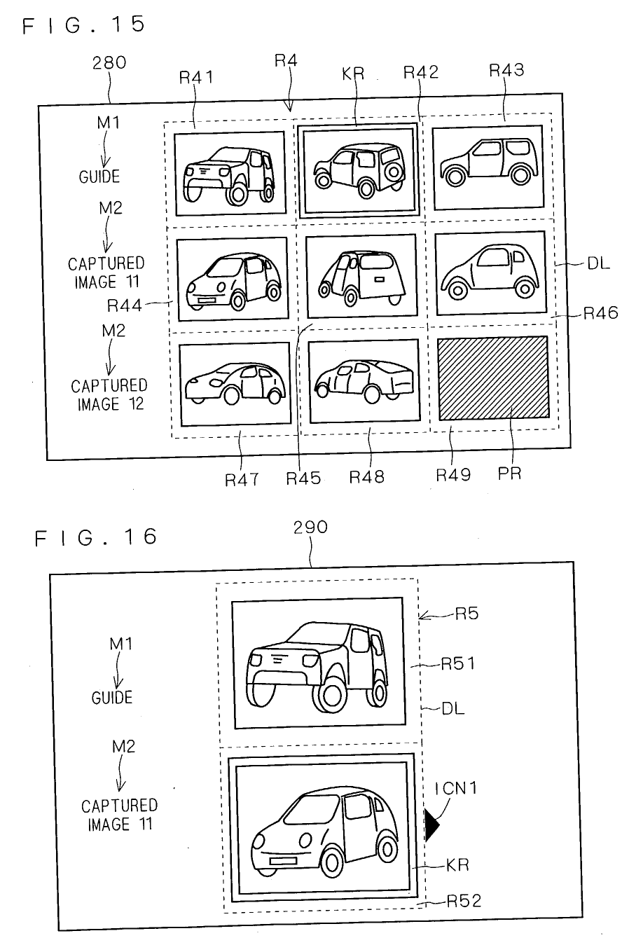

In the “index display screen” 280 shown in FIG. 15, an image is displayed in each of areas R41 to R49 obtained by dividing an image display area R4 of the liquid crystal monitor 211 into a matrix of three rows and three columns. The three images in the first row (areas R41 to R43) are three guide images (“guide image 1001”, “guide image 1002”, and “guide image 1003”) stored in the “guide image 1” folder. Three images in the second row (areas R44 to R46) are three captured images (“captured image 1101”, “captured image 1102”, and “captured image 1103”) stored in the “captured image 11” folder. Three images in the third row (areas R47 to R49) are two captured images (“captured image 1201” and “captured image 1202”) stored in the “captured image 11” folder and the alternative image PR. In the “captured image 12” folder, an image to which the “guide image 1003” is linked is not stored, so that the alternative image PR as a dummy is displayed in the third row and the third column (area R49).

In the case of the display screen, a group of linked images is displayed in the same column (for example, the areas R41, R44, and R47). Specifically, a group of linked images are laid out in the vertical direction of the liquid crystal monitor 211. In this case as well, in a manner similar to the case of the “default display screen” 270, images in the vertical direction are arranged according to the “basic layout” described with respect to the generalized image display apparatus 1. Images in the lateral direction are arranged on the basis of the “applied layout” described with respect to the generalized image display apparatus 1.

By such a display method, even when a number of images are simultaneously displayed, the user can easily grasp images to be compared with each other. Since such displaying operation is automatically performed, the user does not have to perform complicated operations, and images to be compared with each other can be also prevented from being erroneously recognized.

(B) Folder-contents Display Screen Group

A folder-contents display screen group includes “folder-contents display screen (one image)” and “folder-contents display screens (plural images)”. On the display screens, as their names suggest, the numbers of captured images simultaneously displayed are different from each other. The display screens are different from each other with respect to the point that a guide image is also displayed in “folder-contents display screen (one image)” whereas no guide image is displayed in the “folder-contents display screen (plural images)”.

Folder-contents Display Screen (One Image)

The “folder-contents display screen (one image)” corresponds to a display screen obtained by decreasing the number of columns in the “default display screen” 271 to one. The “folder-contents display screen (one image)” is a display screen on which selected one guide image and a captured image to which the guide image is linked are simultaneously displayed on the liquid crystal monitor 211.

FIG. 16 shows an example of a “folder-contents display screen (one image)” 290. In the “folder-contents display screen (one image)” 290, the “guide image 1001” is displayed in an upper area R51 obtained by dividing an image display area R5 of the liquid crystal monitor 211 into a matrix of two rows and one column. In a lower area R52, the “captured image 1101” as a link destination image is displayed. This is a display method corresponding to the “basic layout” described with respect to the generalized image display apparatus 1.

In this case, the group of linked images is laid out in the vertical direction of the liquid crystal monitor 211, so that the user can easily recognize the link relation and compare images without a complicated operation. Further, in the case of the “folder-contents display screen (one image)” 290, the area allocated to display each image can be enlarged as compared with the case of the “default display screen” 270, so that each image can be viewed more easily.

In the “folder-contents display screen (one image)” 290, when there are two or more guide images, all of guide images and captured images as their link destinations cannot be simultaneously displayed. Therefore, to view the images, the scrolling operation described with respect to the “default display screens” 271 and 272 becomes necessary. In the “folder-contents display screen (one image)” 290, the icon ICN1 or ICN2 indicative of the presence of a not-shown captured image is displayed on the liquid crystal monitor 211 (in FIG. 16, only the icon ICN1 is shown), so that the user can perform the scrolling operation in accordance with the instructions. In this case, when the captured image displayed in the lower area R52 is changed, the captured image displayed in the upper area R51 is updated on the basis of the link relation. Specifically, in the case where link relations L(α1→β1), L(α2→β2), L(β1→α1), and L(β2→α2) are defined between guide images α1 and α2 and captured images β1 and β2, and the guide image α1 and the captured image β1 are displayed on the liquid crystal monitor 211, when a captured image to be displayed is changed to the captured image β2, a guide image simultaneously displayed is also updated to the guide image α2 of which link relation with the captured image β2 is defined. That is, scroll denotes a change in the link relation as a reference of display.

Also in the “folder-contents display screen (one image)” 290, in a manner similar to the case of the “default display screen” 270, if a captured image to which a guide image is linked does not exist, the alternative image PR as a dummy is displayed.

Folder-contents Display Screen (Plural Images)

The “folder-contents display screen (plural images)” is a display screen for simultaneously displaying two captured images stored in a selected captured image folder.

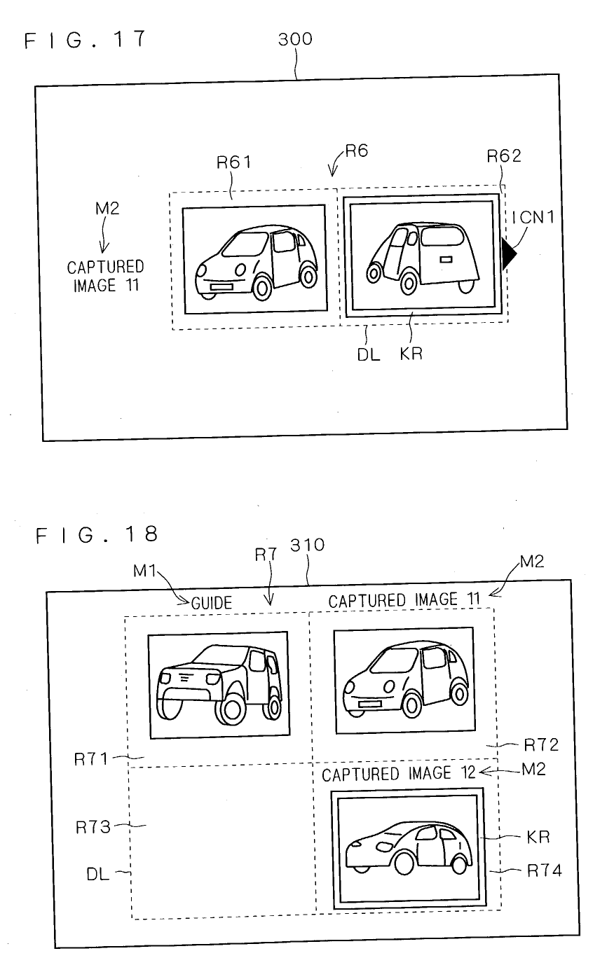

FIG. 17 shows an example of a “folder-contents display screen (plural images)” 300. In the “folder-contents display screen (plural images)” 300, the “captured image 1101” and “captured image 1102” are displayed in areas R61 and R62, respectively, which are obtained by dividing an image display area R6 of the liquid crystal monitor 211 into a matrix of one row and two columns. Also in the “folder-contents display screen (plural images)” 300, the icons ICN1 and ICN2 are properly displayed. By performing scrolling in a manner similar to the “index display screen” 270 or the like, the user can sequentially view all of captured images in the captured image folder.

Comparison Display Screen Group

A comparison display screen group includes a “comparison display screen (plural images)” and a “comparison display screens (one image)”. On the display screens, as their names suggest, the numbers of captured images simultaneously displayed are different from each other.

Comparison Display Screen (Plural Images)

The “comparison display screen (plural images)” corresponds to a display screen on which a selected guide image (for example, “guide image 1001 ”) and captured images (“captured image 1101 ” and “captured image 1201”) to which the guide image is linked are simultaneously displayed. In a “comparison display screen (plural images)” 310 illustrated in FIG. 18, an image is displayed in each of areas R71 to R74, except for an area R73 in the second row and the first column, obtained by dividing an image display area R7 of the liquid crystal monitor 211 into a matrix of two rows and two columns. The images in the first row and the first column (area R71), in the first row and the second column (area R72), and in the second row and the second column (area R73) are “guide image 1001”, “captured image 1101”, and “captured image 1201”. On the display screen, guide images are laid out in the first column (areas R71 and R73) and captured images are laid out in the second column (areas R72 and R74). Specifically, images in the lateral direction are arranged on the basis of the “basic layout” described with respect to the generalized image display apparatus 1, and images in the vertical direction are arranged on the basis of the “applied layout” described with respect to the generalized image display apparatus 1.

By the display method, the user can easily grasp the presence of the link relation between images displayed in the first and second columns and does not erroneously recognize images to be compared with each other.

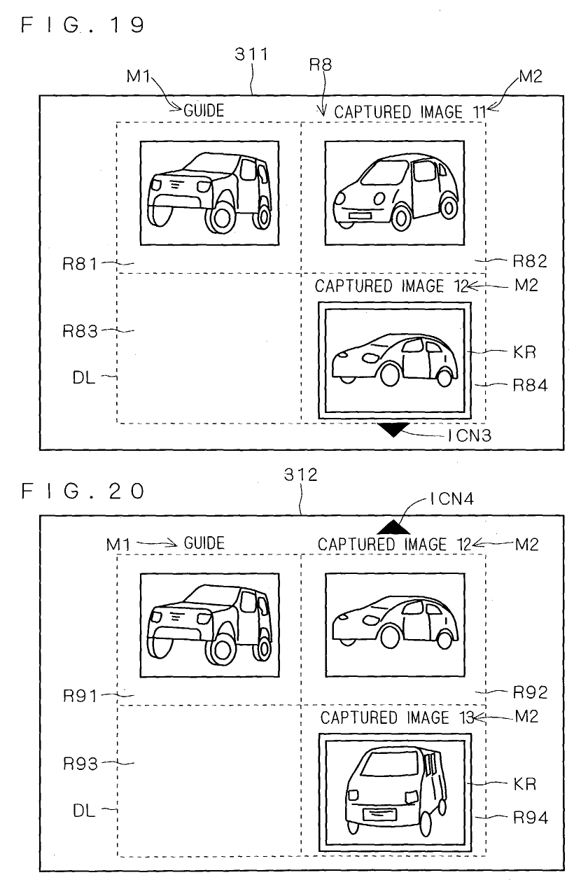

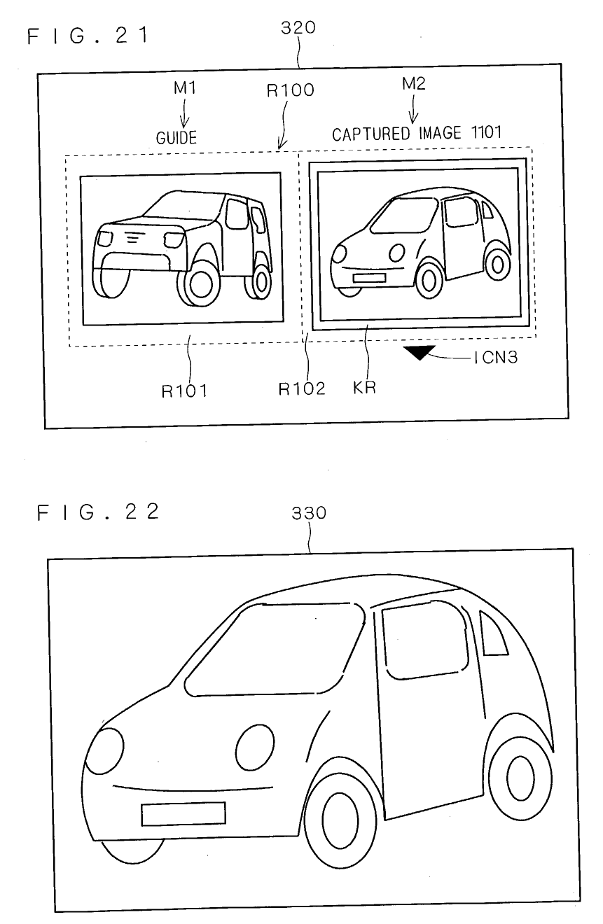

FIGS. 19 and 20 show a modification of the “comparison display screen (plural images)” 310. “Comparison display screens (plural images) 311 and 312 of FIGS. 19 and 20 are displayed in the case where there are three or more captured image folders as child folders of the guided image capturing folder. For example, the “comparison display screens” 311 and 312 are used in the case where a “captured image 13” folder exists in addition to the “captured image 11” folder and the “captured image 12” folder and a “captured image 1301” to which the “guide image 1001” is linked is stored in the “captured image 13” folder. In this case, since all of captured images to which the “guide image 1001” is linked cannot be displayed simultaneously, the scrolling operation becomes necessary. Specifically, the following screens (1) and (2) have to be switched by the scrolling operation and displayed.

(1) The “comparison display screen (plural images)” 311 in which “guide image 1001”, “captured image 1101”, and “captured image 1201” are displayed in areas R81, R82, and R84, respectively.

(2) The “comparison display screen (plural images)” 312 in which “guide image 1001”, “captured image 1201”, and “captured image 1203” are displayed in areas R91, R92, and R94, respectively. On the lower side of the “captured image 1201” in the “comparison display screen (plural images)” 311 in FIG. 19, an icon ICN3 of a down-pointing arrow indicative of the presence of the not-shown “captured image 1301” is displayed. On the upper side of the “captured image 1201” of the “comparison display screen (plural images)” 312 of FIG. 20, an icon ICN4 of an up-pointing arrow indicative of the presence of the not-shown “captured image 1101 ” is displayed.

In the case where the icon ICN3 is displayed on the liquid crystal monitor 211, when the cursor key 212 is operated to move the cursor KR to the “captured image 1201” below which the icon ICN3 is displayed and further move the cursor KR downward, the screen displayed on the liquid crystal monitor 211 changes from the “comparison display screen (plural images)” 311 to the “comparison display screen (plural images)” 312. On the contrary, in the case where the icon ICN4 is displayed on the liquid crystal monitor 211, when the cursor key 212 is operated to move the cursor KR to the “captured image 1201” over which the icon ICN4 is displayed and further move the cursor KR upward, the screen displayed on the liquid crystal monitor 211 changes from the “comparison display screen (plural images)” 312 to the “comparison display screen (plural images)” 311. Since the display position of the “guide image 1001” does not change at this time, a visual effect such that as if only captured images on the right side are scrolled is obtained.

By such display screens, a larger image can be displayed and the details of an image can be viewed more easily while preventing erroneous recognition of images and a link relation. Further, by displaying the icons ICN3 and ICN4 each indicative of a scrollable direction on the liquid crystal monitor 211, the user can easily recognize the scrollable direction and, consequently, can know the cursor operation for displaying a desired image.

Although the direction of scroll in the display screens of the folder-contents display screen group is the lateral direction, the direction of scroll in the comparison display screen group is the vertical direction. This means that the scroll in the lateral direction corresponds to movement in the captured image folder, and the scroll in the vertical direction corresponds to movement between captured image folders. By changing the direction of scroll in accordance with the relation in the depth direction of the hierarchical structure of a folder, it becomes possible to make the user intuitively understand the operation of the cursor key 212 necessary to display a desired image. Since the link relation is defined in the lateral direction (the same hierarchy) of a hierarchical structure of a folder in the first preferred embodiment, it can be also said that the direction of scroll is changed according to the direction of a link relation.

Comparison Display Screen (One Image)

The “comparison display screen (one image)” corresponds to a case where the number of captured images displayed is changed to one in each of the “comparison display screens (plural images)” 311 and 312, that is, the number of rows in a matrix is changed to one.

FIG. 21 shows an example of a “comparison display screen (one image)” 320. In the “comparison display screen (one image)” 320 of FIG. 21, the “guide image 1001” is displayed in an area R101 on the left side obtained by dividing an image display area R100 on the liquid crystal monitor 211 into a matrix of one row and two columns. In an area R102 on the right side, the “captured image 1101” as an image to which the “guide image 1001” is linked is displayed. That is, images in the lateral direction are arranged on the basis of the “basic layout” described with respect to the generalized image display apparatus 1.

On the “comparison display screen (one image)” 320, in the case where the number of captured images to which the “guide image 1001” is linked is two or more, all of captured images cannot be displayed simultaneously. Therefore, to view the images, the scrolling operation described with respect to the “comparison display screens (plural images)” 311 and 312 becomes necessary. Also in the “comparison display screen (one image)” 320, the icon ICN3 or ICN4 indicative of the presence of a not-shown captured image is displayed on the liquid crystal monitor 211 (only the icon ICN3 is shown in FIG. 21), so that the user can perform the scrolling operation in accordance with the instruction. In this case, the captured image displayed in the area R102 on the right side is changed but the captured image displayed in the area R101 on the left side is not updated for the reason that link relations L(α1→β1), L(α1→β2), L(β1→α1), and L(β2→α1) are defined between the guide image α1 and captured images β1 and β2. In the case where the guide image α1 and the captured image β1 are displayed on the liquid crystal monitor 211, even when a captured image to be displayed is changed to the captured image β2 and the link relation to be referred to changes, the guide image as the link source of the captured image remains the guide image α1.

In this case as well, the group of linked images is laid out in the lateral direction of the liquid crystal monitor 211, so that the user can easily recognize the link relation and can compare images without performing a complicated operation. Further, in the case of the “comparison display screen (one image)” 320, the area allocated to display each image can be enlarged as compared with the case of the “comparison display screen (plural images)” 312, so that an each image can be viewed more easily.

Also in the “comparison display screen (one image)” 320, in a manner similar to the case of the “default display image” 270, when a captured image to which the guide image is linked does not exist, the alternative image PR as a dummy is displayed.

(D) Enlarged Display Screen Group

An enlarged display screen group includes an “enlarged display screen (without a guide image)” and an “enlarged display screen (with a guide image)”. The display screens are, as their names suggest, different from each other with respect to the point whether or not a guide image as a link destination is displayed or not simultaneously with a captured image displayed.

Enlarged Display Screen (Without Guide Image)

An “enlarged display screen (without a guide image)” is a display screen on which a selected captured image (for example, “captured image 1101”) is enlarged to the whole image display area of the liquid crystal monitor 211 and displayed. FIG. 22 shows a concrete example as an “enlarged display screen (without a guide image)” 330.

Enlarged Display Screen (With Guide Image)

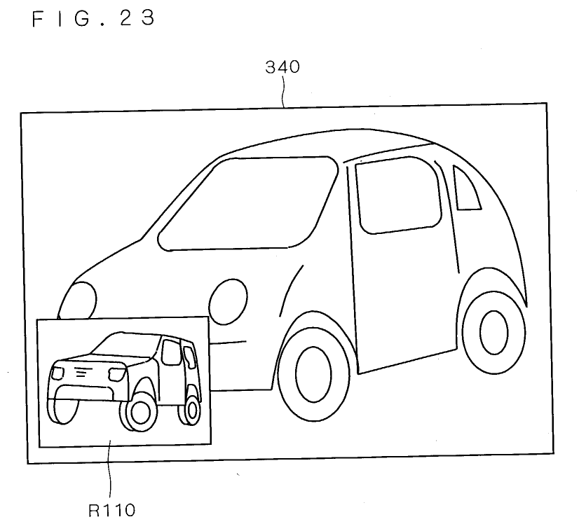

An “enlarged display screen (with a guide image)” is a display screen in which a guide image (for example, “guide image 1001”) to which an enlargedly shown captured image (“captured image 1101”) is linked is displayed in an area as a part of the “enlarged display screen (without a guide image)”. The guide image (the area R110) is displayed while masking the captured image as shown in an “enlarged display screen (with a guide image)” 340 of FIG. 23. On the display screen, since a selected captured image is enlarged, the details of the captured image can be recognized. Since a guide image as a link destination is displayed, a guide image and a captured image can be compared with each other without a complicated operation. This corresponds to a modification of the “basic layout” described with respect to the generalized image display apparatus 1. Switching of display screen in reproduction mode

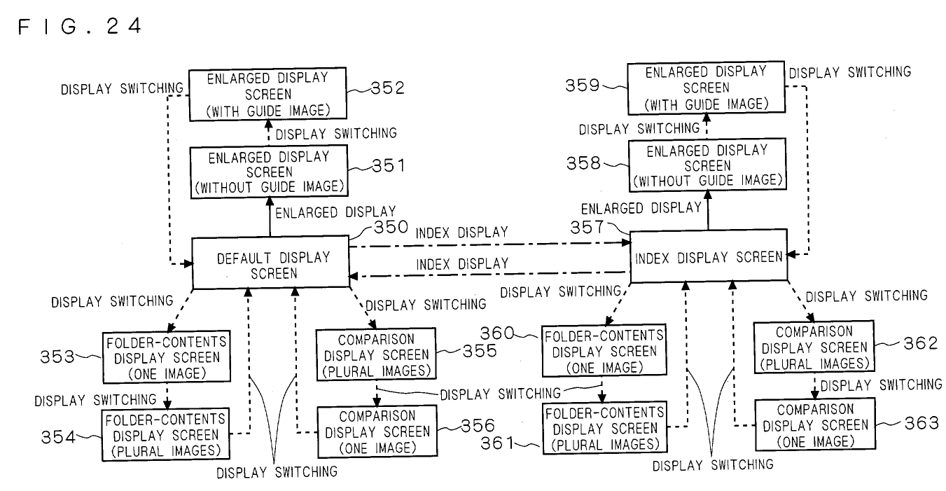

Switching of a display screen in the reproduction mode will be described later with reference to FIGS. 24 to 29.

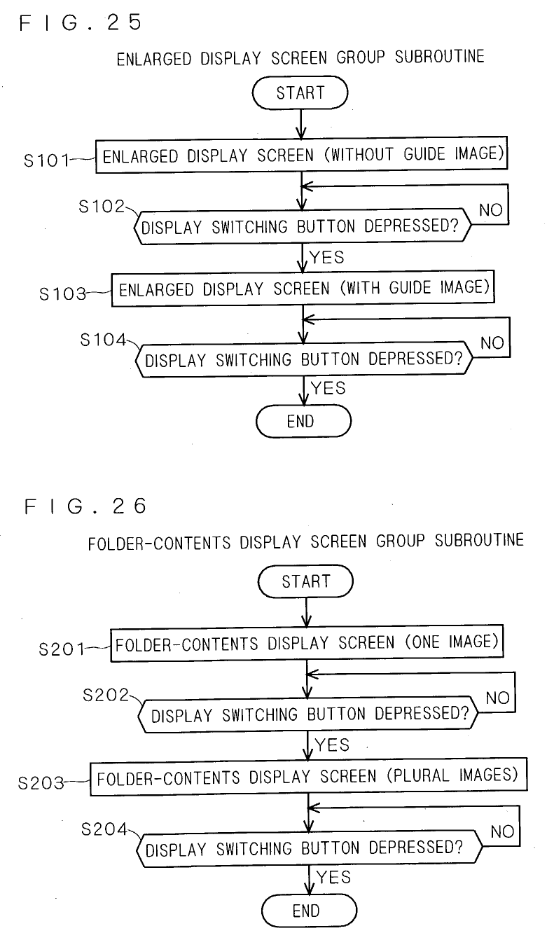

FIG. 24 is a diagram schematically showing a state where a display screen is switched by the display setting button group 215 (display switching button 215a, enlarged display button 215b, and index display button 215c). FIGS. 25 to 29 are flowcharts for describing an operation of switching a display screen in the reproduction mode. First, the outline of switching of a display screen will be described with reference to FIG. 24. After that, the operation of switching the display screen in the reproduction mode will be described with reference to the flowcharts of FIGS. 25 to 29.

First, attention is paid to a “default display screen” 350 in FIG. 24. As described above, on the “default display screen” 350, a plurality of guide images and captured images are displayed. One of the images can be selected with the cursor KR. When the enlarged display button 215b is depressed in a state where a captured image is selected, the display screen is switched to an “enlarged display screen (without a guide image”) 351. When the display switching button 215a is depressed in the “enlarged display screen (without a guide image)” 351, the display screen is switched to an “enlarged display screen (with a guide image)” 352. Further, when the display switching button 215a is depressed in the “enlarged display screen (with a guide image)” 352, the program goes back to the “default display screen” 350.

Attention is paid again to the “default display screen” 350. When a captured image is selected and the display switching button 215a is depressed, the display screen is switched to a “folder-contents display screen (one image)” 353. When the display switching button 215a is depressed in the “folder-contents display screen (one image)” 353, the display screen is switched to a “folder-contents display screen (plural images)” 354. Further, when the display switching button 215a is depressed in the “folder-contents display screen (plural images)” 354, the program goes back to the “default display screen” 350.

Attention is paid again to the “default display screen” 350. When a guide image is selected and the display switching button 215a is depressed, the display screen is switched to a “comparison display screen (plural images)” 355. When the display switching button 215a is depressed in the “comparison display screen (plural images)” 355, the display screen is switched to a “comparison display screen (one image)” 356. Further, when the display switching button 215a is depressed in the “comparison display screen (one image)” 356, the program goes back to the “default display screen” 350.

Attention is paid again to the “default display screen” 350. When the index display button 215c is depressed in the screen (irrespective of the position of the cursor KR), the display screen is switched to an “index display screen” 357. When the index display button 215c is depressed in the “index display screen” 357 (irrespective of the position of the cursor), the program goes back to the “default display screen” 350.

Attention is paid to the “index display screen” 357. As described above, in the “index display screen” 357, a plurality of guide images and captured images are displayed and one of the images can be selected with the cursor KR. When the enlarged display button 215b is depressed in a state where the captured image is selected, the display screen is shifted to an “enlarged display screen (without a guide image)” 358. When the display switching button 215a is depressed in the “enlarged display screen (without a guide image) 358, the display screen is shifted to an “enlarged display screen (with a guide image)” 359. Further, when the display switching button 215a is depressed in the “enlarged display screen (with a guide image)” 359, the program goes back to the “index display screen” 357.

Attention is paid again to the “index display screen” 357. When a captured image is selected and the display switching button 215a is depressed, the display screen is shifted to a “folder-contents display screen (one image)” 360. When the display switching button 215a is depressed in the “folder-contents display screen (one image)” 360, the display screen is shifted to a “folder-contents display screen (plural images)” 361. Further, when the display switching button 215a is depressed in the “folder-contents display screen (plural images)” 361, the program goes back to the “index display screen” 357.

Attention is paid again to the “index display screen” 357. When a guide image is selected and the display switching button 215a is depressed, the display screen is shifted to a “comparison display screen (plural images)” 362. When the display switching button 215a is depressed in the “comparison display screen (plural images)” 362, the display screen is shifted to a “comparison display screen (one image)” 363. Further, when the display switching button 215a is depressed in the “comparison display screen (one image)” 363, the program goes back to the “index display screen” 357.

Since an operation which is not defined in the above description is recognized as an invalid operation by the digital camera 2, the display screen is not switched.

The functions of the display switching button 215a, enlarged display button 215b, and index display button 215c are summarized as follows.

(1) Display Switching Button 215a

First, the display switching button 215a is used to shift from the list display screen group to the folder-contents display screen group or comparison display screen group. The destination group changes according to an image selected when the display switching button 215a is selected. When the display switching button 215a is depressed in a state where a captured image is selected, the display screen is shifted to the folder-contents display screen group. This means that when a captured image is selected, the display screen is shifted to a screen on which images in the same folder are mainly viewed. On the other hand, when the display switching button 215a is depressed in a state where a guide image is selected, the display screen is shifted to the comparison display screen group. This means that when a guide image is selected, the display screen is shifted to a display screen on which an image as a link destination is mainly viewed.

The display switching button 215a is also used to switch a display screen in the folder-contents display screen group, comparison display screen group, and enlarged display screen group and to return to the index display screen group.

(2) Enlarged Display Button 215b

The enlarged display button 215b is used to shift from the list display screen group to the enlarged display screen group.

(3) Index Display Button 215c

The index display button 215c is used to switch a display method in the list display screen group.

The display screen switching is constructed by equivalent two switching systems using two list display screens (default display screen 350 and index display screen 357) as base points. The default display screen 350 and index display screen 357 can be sequentially switched by the index display button 215c.

Subsequently, the operation flow in the reproduction mode will be described with reference to the flowcharts of FIGS. 25 to 29. In the description of the operation flow, first, a subroutine of an operation flow of display screen switching among the folder-contents display screen group, comparison display screen group, and enlarged display screen group and a subroutine as a display switching system using the index display screen as a base point are defined. After that, the general operation flow will be described by using the defined subroutines.

Enlarged Display Screen Group Subroutine

An enlarged display screen group subroutine adapted to display screen switching among the enlarged display screen group will be defined. In the following, the subroutine will be described with reference to the flowchart of FIG. 25.

First, when the subroutine starts, the operation flow shifts to step

In step S101, the “enlarged display screen (without guide image)” 330 is displayed on the liquid crystal monitor 211 and, the operation flow moves to step S102.

In step S102, whether the display switching button 215a is depressed or not is detected. When depression of the display switching button 215a is detected, the operation flow moves to step S103. When depression of the display switching button 215a is not detected, the operation flow returns to step S102. That is, until the display switching button 215a is depressed, the “enlarged display screen (without guide image)” 330 is continuously displayed on the liquid crystal monitor 211.

In step S103, the “enlarged display screen (with a guide image)” 340 is displayed on the liquid crystal monitor 211 and the operation flow shifts to step S104.

In step S104, in a manner similar to step S102, whether the display switching button 215a is depressed or not is detected. When depression of the display switching button 215a is detected, the subroutine is finished. When depression of the display switching button 215a is not detected, the operation flow returns to step S104. That is, until the display switching button 215a is depressed, the “enlarged display screen (with guide image)” 340 is continuously displayed on the liquid crystal monitor 211.

By the operation flow, until the display switching button 215a is depressed, the same screen is displayed on the liquid crystal monitor 211. When the display switching button 215a is depressed, the display screen is sequentially switched.

In-folder Display Screen Group Subroutine

Subsequently, the folder-contents display screen group subroutine adapted to display screen switching in the folder-contents display screen group will be defined. In the following, the subroutine will be described with reference to the flowchart of FIG. 26.

First, when the subroutine starts, the operation flow shits to step S201.

In step S201, the “folder-contents display screen (one image)” 290 is displayed on the liquid crystal monitor 211 and the operation flow shifts to step S202.

In step S202, whether the display switching button 215a is depressed or not is detected. When depression of the display switching button 215a is detected, the operation flow shifts to step S203. When depression of the display switching button 215a is not detected, the operation flow returns to step S202. That is, until the display switching button 215a is depressed, the “folder-contents display screen (one image)” 290 is continuously displayed on the liquid crystal monitor 211.

In step S203, the “folder-contents display screen (plural images)” 300 is displayed on the liquid crystal monitor 211, and the operation flow shifts to step S204.

In step S204, in a manner similar to step S202, whether the display switching button 215a is depressed or not is detected. When depression of the display switching button 215a is detected, the subroutine is finished. When depression of the display switching button 215a is not detected, the operation flow returns to step S204. That is, until the display switching button 215a is depressed, the “folder-contents display screen (plural images)” 300 is continuously displayed on the liquid crystal monitor 211.

By the operation flow, the same screen is displayed on the liquid crystal monitor 211 until the display switching button 215a is depressed. When the display switching button 215a is depressed, the screen displayed is sequentially switched.

Comparison Display Screen Group Subroutine

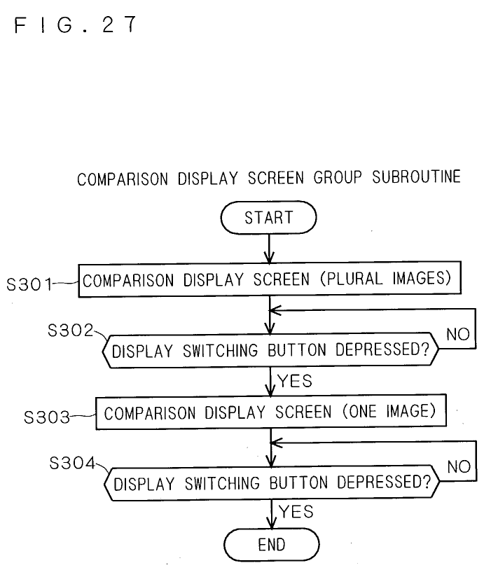

Subsequently, the comparison display screen group subroutine adapted to display screen switching in the comparison display screen group will be defined. In the following, the subroutine will be described with reference to the flowchart of FIG. 27.

First, when the subroutine starts, the operation flow shits to step S301.

In step S301, the “comparison display screen (plural images)” 310 is displayed on the liquid crystal monitor 211, and the operation flow shifts to step S302.

In step S302, whether the display switching button 215a is depressed or not is detected. When depression of the display switching button 215a is detected, the operation flow shifts to step S303. When depression of the display switching button 215a is not detected, the operation flow returns to step S302. That is, until the display switching button 215a is depressed, the “comparison display screen (plural images)” 310 is continuously displayed on the liquid crystal monitor 211.

In step S303, the “comparison display screen (one image)” 320 is displayed on the liquid crystal monitor 211, and the operation flow shifts to step S304.

In step S304, in a manner similar to step S302, whether the display switching button 215a is depressed or not is detected. When depression of the display switching button 215a is detected, the subroutine is finished. When depression of the display switching button 215a is not detected, the operation flow returns to step S304. That is, until the display switching button 215a is depressed, the “comparison display screen (plural images)” 320 is continuously displayed on the liquid crystal monitor 211.

By the operation flow, the same screen is displayed on the liquid crystal monitor 211 until the display switching button 215a is depressed. When the display switching button 215b is depressed, the screen displayed is sequentially switched.

Index Display Screen Subroutine

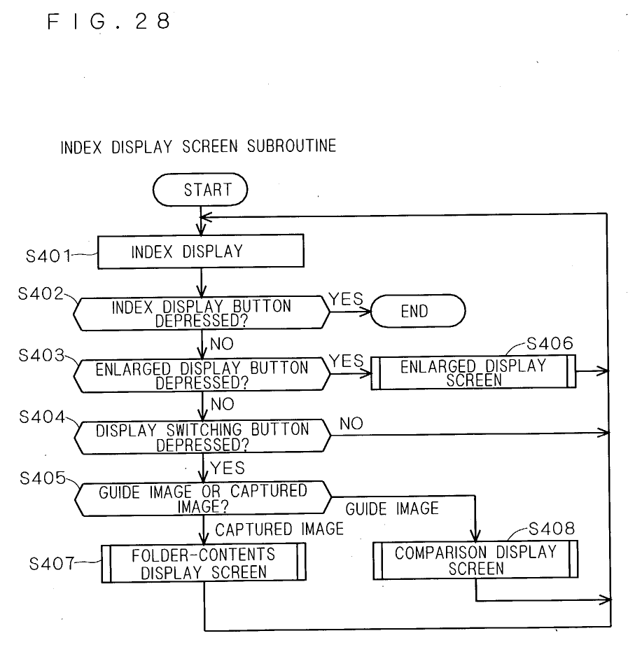

The index display screen subroutine as a display switching system using the index display screen as a base point will be described with reference to the flowchart of FIG. 28. The subroutine is defined by using the enlarged display screen group subroutine, folder-contents display screen group subroutine, and comparison display screen group subroutine which have been defined above. The subroutine is a subroutine corresponding to the right half (portion using the index display screen as a base point) of the display screen switching system of FIG. 24.

First, when the index display screen subroutine starts, the operation flow shits to step S401.

In step S401, the “index display screen” 280 is displayed on the liquid crystal monitor 211 and the operation flow shifts to step S402.

In step S402, whether the index display button 215c is depressed or not is detected. When depression of the index display button 215c is detected, the subroutine is finished. When depression of the index display button 215c is not detected, the operation flow shifts to step S403.

In step S403, whether the enlarged display button 215b is depressed or not is detected. When depression of the enlarged display button 215b is detected, the operation flow shifts to the enlarged display screen group subroutine in step S406. When the depression of the enlarged display button 215b is not detected, the operation flow shifts to step S404.

In step S404, whether the display switching button 215a is depressed or not is detected. When depression of the display switching button 215a is detected, the operation flow shifts to step S405. When depression of the display switching button 215a is not detected, the operation flow returns to step S401.

In step S405, a branched process is performed according to the kind of an image selected by the cursor KR in the “index display screen” 280 upon depression of the display switching button 215a. In the case where a guide image is selected, the operation flow shifts to a folder-contents display screen group subroutine in step S407. In the case where a captured image is selected, the operation flow shifts to the comparison display screen group subroutine in step S408.

After completion of the subroutine of steps S406 to S408, the operation flow returns to step S401.

By such an operation flow, according to the kind of a button depressed in a state where the index display screen is displayed, the display screen is switched. Further, in the case where the display switching button 215a is depressed, according to the kind of an image selected at that time, the display screen is switched.

General Operation Flow in Reproduction Mode

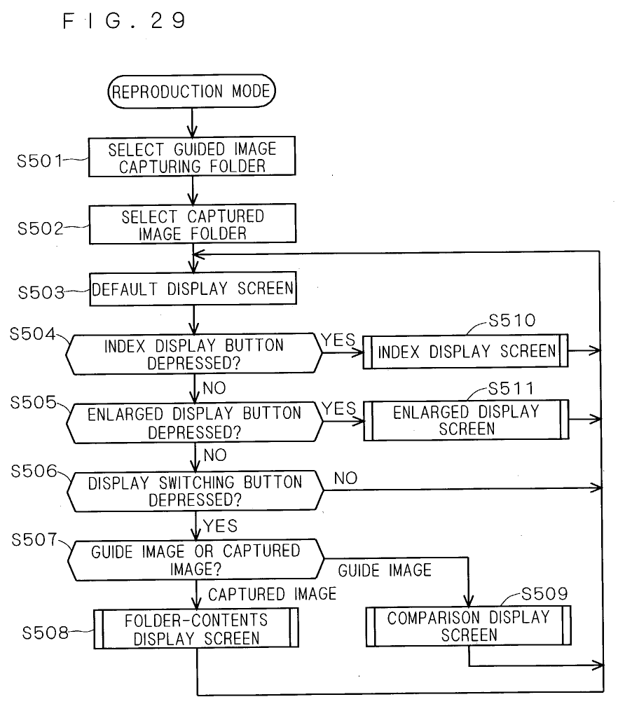

In the following, the whole operation flow in the reproduction mode will be described with reference to the flowchart of FIG. 29 by using the subroutines defined above. The display screen displayed first in the reproduction mode is, as suggested from the name, the “default display screen” 270. In the “default display screen” 270, however, one captured image folder to be displayed has to be selected. Consequently, in the operation flow of the reproduction mode, in the first two steps (steps S501 and S502), a captured image folder to be displayed is specified. After that, the “default display screen” 270 is displayed.

The operation flow in the reproduction mode will be described in order.

First, when the digital camera 2 shifts to the reproduction mode, the operation flow of the reproduction mode starts and advances to step S501 in FIG. 29.

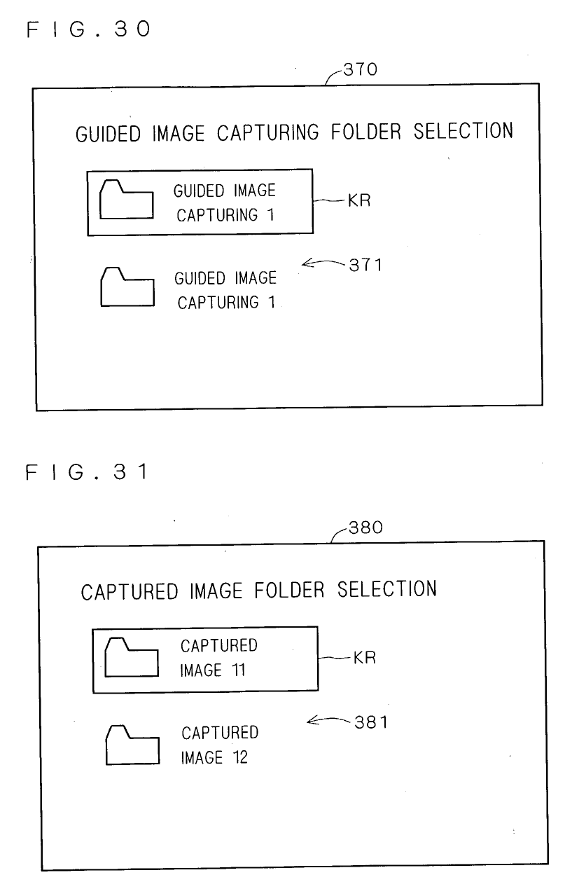

In step S501, a “guided image capturing folder selection screen” 370 illustrated in FIG. 30 is displayed on the liquid crystal monitor 211. In the “guided image capturing folder selection screen” 370, a list 371 of guided image capturing folders is displayed. The cursor KR is superimposed on one of the guided image capturing folders. The user can move the position of the cursor KR by using the cursor key 212. Further, when the user depresses the execution button 213, the guided image capturing folder on which the cursor KR is superimposed is recognized as a selected guided image capturing folder by the digital camera 2. The operation flow shits to the next step S502.

In step S502, a “captured image folder selection screen” 380 illustrated in FIG. 31 is displayed on the liquid crystal monitor 211. In the “captured image folder selection screen” 380, a list 381 of captured image folders in the lower layer of the guided image capturing folder selected in step S501 is displayed. In the list as well, the cursor KR similar to that in the “guided image capturing folder selection screen” 370 is displayed. The user can make the digital camera 2 recognize one of the captured image folders as a selected captured image folder by using the cursor key 212 and execution button 213. After completion of the processes, the operation flow shifts to step S503.

Since the captured image folder is specified in steps S501 and S502, in the following step S503, the “default display screen” 270 regarding the captured image folder can be displayed. In step S503, the “default display screen” 270 is displayed on the liquid crystal monitor 211 and the operation flow shifts to step S504.

In step S504, depression of the index display button 215c is detected. When depression of the index display button 215c is detected, the operation flow shifts to the index display screen subroutine in step S510. When depression of the index display button 215c is not detected, the operation flow shifts to step S505.

In step S505, depression of the enlarged display button 215b is detected. When depression of the enlarged display button 215b is detected, the operation flow shifts to the enlarged display screen group subroutine of step S511. When depression of the enlarged display button 215b is not detected, the operation flow shifts to step S506.

In step S506, depression of the display switching button 215a is detected. When depression of the display switching button 215a is detected, the operation flow shifts to step S507. When depression of the display switching button 215a is not detected, the operation flow shifts to step S503.

In step S507, a branched process is performed according to the kind of an image selected by the cursor KR in the “index display screen” 280 upon depression of the display switching button 215a. In the case where a guide image is selected, the operation flow shifts to a folder-contents display screen group subroutine in step S508. In the case where a captured image is selected, the operation flow shifts to the comparison display screen group subroutine in step S509.

After completion of the subroutine of steps S508 to S511, the operation flow returns to step S503.

By such an operation flow, according to the kind of a button depressed in a state where the default display screen is displayed, the display screen is switched. Further, in the case where the display switching button 215a is depressed, according to the kind of an image selected at that time, the display screen is switched.

New Image Capturing Mode

In the following, the new image capturing mode of the digital camera 2 will be described. The new image capturing mode is an operation mode of newly generating the captured image folder and performing guided image capturing. In the new image capturing mode, a captured image is stored in the newly generated image capturing image folder.

In the new image capturing mode of the digital camera 2, to perform guided image capturing, a guide image to be used has to be specified prior to image capturing. For this purpose, the operation flow of the new image capturing mode includes a step (S601) in which a guided image capturing folder is selected by the user and a step (S603) in which a guide image is selected by the user. To view a captured image later, the user has to know the folder name of a newly generated captured image folder in which a captured image is stored. Consequently, the operation flow of the new image capturing mode includes a step (S602) of notifying the user of the folder name of a newly generated captured image folder.

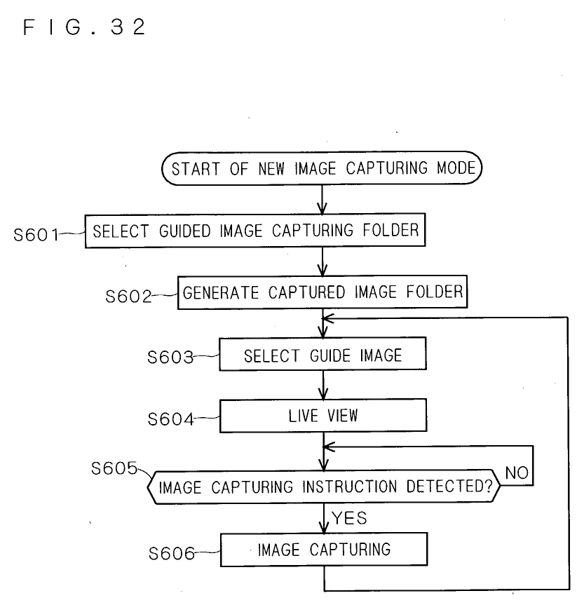

The operation flow of the new image capturing mode will be described in order with reference to the flowchart of FIG. 32.

First, when the digital camera 2 shifts to the reproduction mode, the operation flow of the new image capturing mode starts and advances to step S601.

In step S601, a screen equivalent to the “guided image capturing folder selection screen” 370 illustrated in FIG. 30 is displayed on the liquid crystal monitor 211. In step S601, therefore, the user can make the digital camera 2 recognize the guided image capturing folder in which a guide image used for guided image capturing is stored. After completion of the process, the operation flow shits to the next step S602.

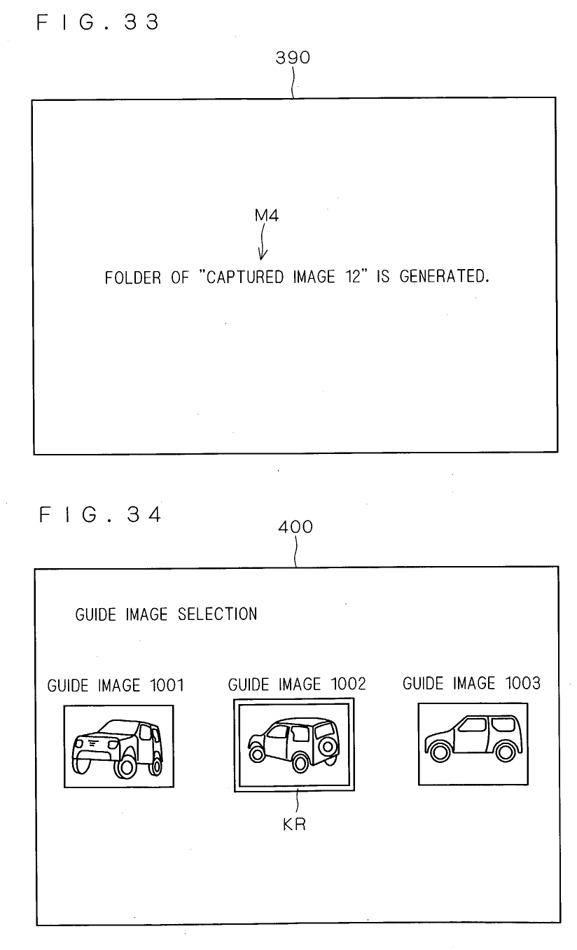

In step S602, a captured image folder in which a captured image is stored is generated. A new captured image folder is generated in the same hierarchy as a guide image folder, as a child folder of the guided image capturing folder selected in step S601. The folder name of the captured image folder is determined so as not to be the same as that of an existing captured image folder (it is now assumed that the “captured image 11” folder exists as an existing captured image folder and the “captured image 12” folder is newly generated). In the tag of the captured image folder, the folder name of a guide image folder (“guide image 1” folder) existing in the same hierarchy is written. Further, in the tag of the “guide image 1” folder, the folder name of the “captured image 12” folder is written. The folder name of the newly generated captured image folder is displayed as a message for predetermined time on the liquid crystal monitor 211. FIG. 33 shows an example of the message. In a “message screen” 390 of FIG. 33, a character sequence M4 of ““captured image 12” folder is generated” is displayed, thereby making the user recognize the folder name of the generated captured image folder. After completion of the processes, the operation flow shifts to the next step S603.

In step S603, a “guide image selection screen” 400 illustrate din FIG. 34 is displayed on the liquid crystal monitor 211. On the guide image selection screen 400, a list of a plurality of guide images (“guide image 1001”, “guide image 1002”, and “guide image 1003”) stored in the “guide image 1” folder is displayed on the liquid crystal monitor 211. The cursor KR is superimposed on one of the guide images displayed and the user can move the position of the cursor KR by using the cursor key 212. Further, by depressing the execution button 213, it is possible to make the digital camera 2 recognize the guide image on which the cursor KR is superimposed as a guide image to be used. After completion of the processes, the operation flow shifts to step S604.

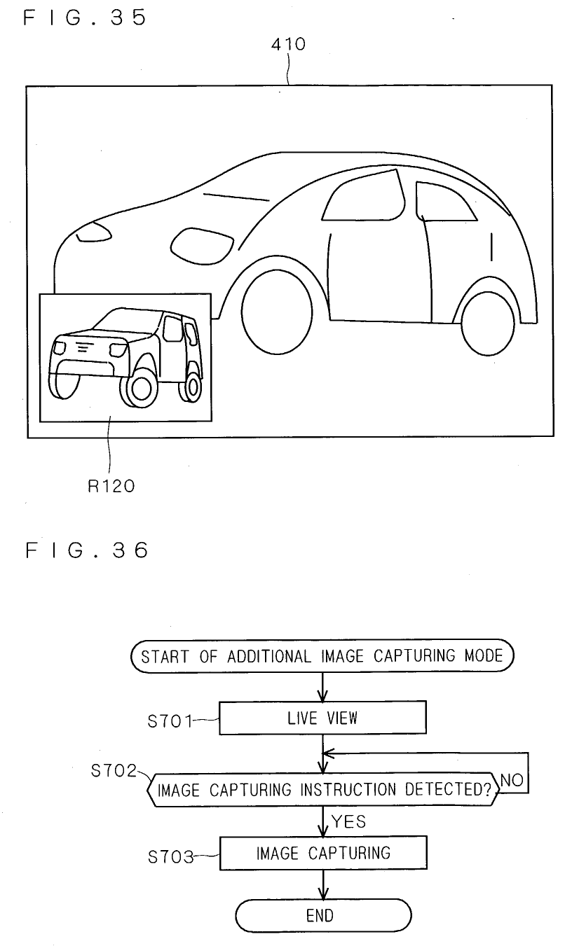

In step S604, a live view of the subject is displayed on the liquid crystal monitor 211 and, the operation flow shifts to the next step S605. As shown in a “live view display screen” 410 of FIG. 35, the live view is displayed on the whole liquid crystal monitor 211 while a subject image obtained via a taking lens is updated at predetermined time intervals and the guide image selected in step S603 is displayed in an area R120 as a part of the liquid crystal monitor 211. The live view is masked with a guide image in the area R120. By such display, the user can frame the image while seeing the composition of the guide image, so that a captured image in almost the same composition as that of the guide image can be obtained. Obviously, the guide image displaying method is not limited to the method.

In step S605, a branched process is performed according to the presence/absence of an image capturing instruction with the release button 205. Specifically, when it is detected that the release button 205 is depressed by the user, the operation flow shifts to step S606. When depression of the release button 205 is not detected, the operation flow shifts to step S605. In such a manner, step S605 is repeated until depression of the release button 205 is detected.

In step S606, an image capturing process is performed. Specifically, a subject image obtained through the captured image lens 202 is converted to an image and stored in the file format of Exif in the captured image folder (“captured image 12” folder) newly generated in step S602. The file name of the captured image to be stored is determined by a predetermined method (in this case, it is determined as “captured image 1201”). In the tag of the captured image to be stored, the path and the file name of the guide image selected in step S603 are written. Further, also in the tag of the guide image (“guide image 1001”), the path and the file name of the captured image are written. The reason why the tag of the guide image is also updated is to assure the above-described bidirection property of the link relation that images to be compared can be referred to from both of the guide image and the captured image.

After completion of the processes, the operation flow shifts to step S603 and the guide image selection screen is displayed again.

Additional Image Capturing Mode

An additional image capturing mode is an operation mode of obtaining a missing captured image in the case where captured images to which all of guide images already generated are not stored in a captured image folder. That is, it is an operation mode of obtaining a captured image corresponding to an alternative image described in the reproduction mode.

Also in the additional image capturing mode, in a manner similar to the case of the new image capturing mode, to perform guided image capturing, a guide image to be used has to be specified prior to image capturing. However, in the additional image capturing mode, a method of designating a guide image to be used is different from that of the new image capturing mode. Concretely, when the digital camera 2 enters the additional image capturing mode from a state where the alternative image PR is selected with the cursor KR in the reproduction mode, the digital camera 2 recognizes a guide image related to the alternative image as a guide image to be used in the guided image capturing in the additional image capturing mode. A captured image obtained by the image capturing is stored in a captured image folder related to the alternative image PR.

The operation flow of the additional image capturing mode will be described in order with reference to the flowchart of FIG. 36.

First, when the additional image capturing mode starts, the operation flow shifts to step S701.

In step S701, a live view similar to that in step S604 in the new image capturing mode is displayed on the liquid crystal monitor 211, and the operation flow shifts to step S702. A guide image displayed is a guide image related to the alternative image PR selected with the cursor KR in the reproduction mode before the shift to the additional image capturing mode as described above.

In step S702, an image capturing instruction similar to that in step S605 in the new image capturing mode is detected. If the image capturing instruction is detected, the operation flow shifts to step S703. If the image capturing instruction is not detected, the operation flow shifts to step S702.

In step S703, an image capturing process is performed in a manner similar to that in step S606 in the new image capturing mode. However, an image obtained by -image capturing is stored in the captured image folder related to the alternative image PR. After that, the operation flow of the additional image capturing mode is finished.

By the operation flow, the digital camera 2 can obtain a missing captured image in the captured image folder. Consequently, even in the case where the user notices that an image in a necessary composition is missing, the necessary image can be compensated by the simple operation.

Switching of Operation Mode

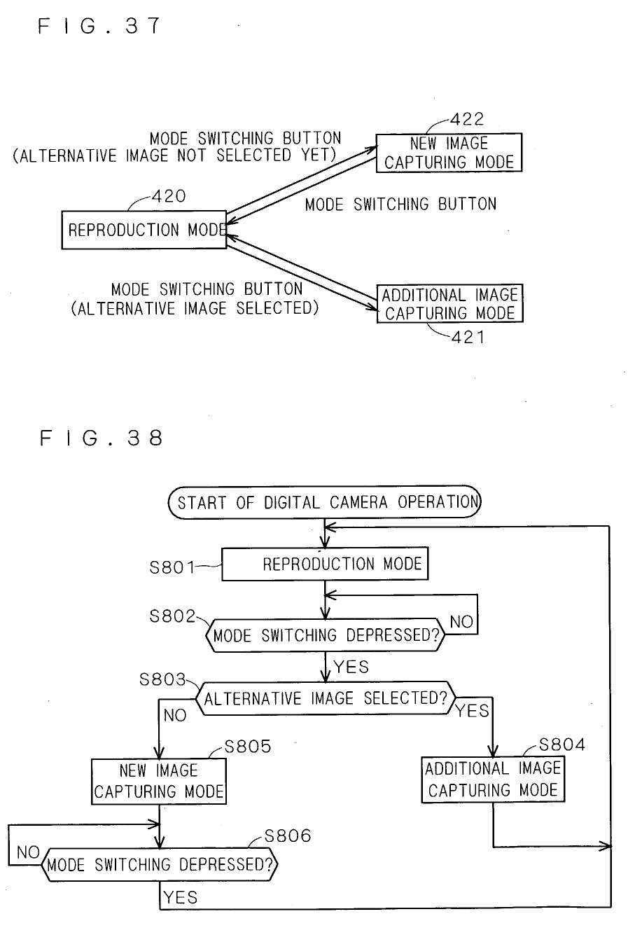

The digital camera 2 has, as described above, the three operation modes consisting of the two image capturing modes of the new image capturing mode and the additional image capturing mode and one reproduction mode. The operation modes can be switched by depressing the mode switching button 207 by a predetermined method. In the following, the method of switching the three operation modes will be described with reference to FIG. 37.

First, attention is paid to a reproduction mode 420 as an operation mode which is set immediately after the power is turned on. When the mode switching button 207 is depressed in a state where the alternative image PR is selected with the cursor KR in the reproduction mode 420, the operation mode of the digital camera 2 shifts from the reproduction mode 420 to an additional image capturing mode 421. By the digital camera 2, a captured image folder related to the alternative image PR is recognized as a folder in which an image captured in the additional image capturing mode is stored, and a guide image related to the alternative image PR is recognized as a guide image used for guided image capturing.

When the mode switching button 207 is depressed in a state where the alternative image PR is selected with the cursor KR in the reproduction mode 420, the operation mode of the digital camera 2 shifts from the reproduction mode 420 to a new image capturing mode 422.

Attention is now paid to the new image capturing mode 422. When the mode switching button is depressed in the new image capturing mode 422, the operation mode shifts from the new image capturing mode 422 to the reproduction mode 420.

Attention is now paid to the additional image capturing mode 421. For the shift from the additional image capturing mode 421 to the reproduction mode 420, a special operation is not required. Specifically, when the image capturing in the additional image capturing mode 421 is finished (when the flowchart of FIG. 36 is finished), the operation mode automatically goes back to the reproduction mode 420.

The operation will now be described with reference to the flowchart of FIG. 38.

First, when the power of the digital camera 2 is turned on by the power switch 206, the operation flow shifts to step S801.

In step S801, the operation mode of the digital camera 2 is set to the reproduction mode 420 as a default and shifts to the following step S802. In the reproduction mode 420, an image stored in the memory card 209 can be viewed on the liquid crystal monitor 211 as described above.

In step S802, depression of the mode switching button 207 is detected. If YES, the operation flow shifts to step S803. If NO, the operation flow returns to step S802 and the reproduction mode 420 is maintained until depression is detected.

In step S803, according to whether the alternative image PR is selected at the time of depression of the mode switching button 207 or not, a branched process is performed. When the alternative image PR is selected, the operation flow shifts to step S804. When it is not selected, the operation flow shifts to step S805.

In step S804, the operation mode of the digital camera 2 is changed to the additional image capturing mode 421. After completion of the additional image capturing process, the operation flow goes back to step S801.

In step S805, the operation mode of the digital camera 2 is changed to the new image capturing mode 422 and, the operation flow shifts to step S806.

In step S807, in a manner similar to step S802, depression of the mode switching button 207 is detected. When depression is detected, the operation flow shifts to step S801. When depression is not detected, the operation flow goes back to step S806 and the new image capturing mode 422 is maintained until depression is detected.

Since depression of the mode switching button 207 is always monitored during the operation flow of the new image capturing mode and the reproduction mode, irrespective of the state of the operation flow, the operation mode shifts. In other words, when the mode switching button 207 is depressed in the new image capturing mode or reproduction mode, the operation flow in the new image capturing mode or reproduction mode is interrupted and the operation mode shifts.

By switching the operation mode as described above, the user can view an image on the liquid crystal monitor 211 of the digital camera 2 and, moreover, execute new guided image capturing or obtain a missing image.

Second Preferred Embodiment

A digital camera 3 of a second preferred embodiment is not constructed to perform guided image capturing, different from the digital camera 2 of the first preferred embodiment. However, the configuration and operation of the digital camera 3 are similar to those of the digital camera 2, so that only different points between the digital cameras 2 and 3 will be described in the following and description of the common parts will not be repeated.

Appearance Configuration of Digital Camera

The digital camera 3 is different from the digital camera 2 with respect to the points that the display switching button 215a in the display setting button group 215 of the digital camera 2 is provided and the enlarged display button 215b and the index display button 215c are omitted. Although the point that a display screen displayed on the liquid crystal monitor 211 is switched by the display switching button 215a is common to the digital cameras 2 and 3, a concrete display screen to be switched in the digital camera 2 and that in the digital camera 3 are different from each other as will be described later.

Internal Configuration of Digital Camera

The internal configuration of the digital camera 3 is similar to that of the digital camera 2, so that its description will not be repeated.

Folder Structure of Memory Card

Since the digital camera 3 does not perform the guided image capturing different from the digital camera 2, the operation of classifying guide images and captured images by using folders and storing the folders in the memory card 209 is not performed. It is sufficient to store a captured image into a predetermined folder in the memory card 209.

Tag

Since the digital camera 3 does not perform the guided image capturing different from the digital camera 2, a link relation regarding guided image capturing is not written in a tag. Therefore, the link destination information 261a in the tag 261 shown in FIG. 10 is not written in the tag at the time of image capturing in the digital camera 3. However, the AF area information 261b is written also in the digital camera 3 and used as a link relation for determining the layout of a display screen as will be described later.

Display Screen

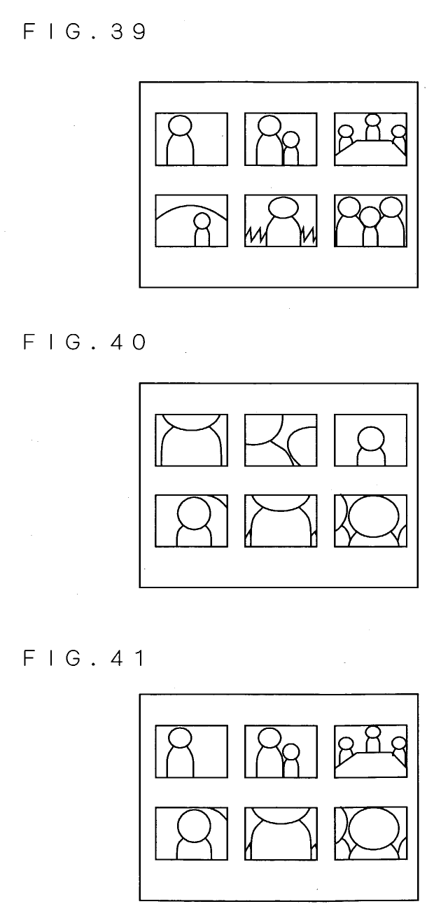

The display screens of the digital camera 3 are “normal display screen”, “AF area display screen”, and “simultaneous display screen”. The “normal display screen” is a display screen for displaying a list of images stored in the memory card 209 as illustrated in FIG. 39. The “AF area display screen” is a display screen for displaying a list of AF areas of the images as illustrated in FIG. 40. According to the display method, the AF area information 261b written in the tag 261 is used as a link information and the “applied layout” described with respect to the generalized image display apparatus 1 is applied for a display screen (symmetry of link relations regarding the folder structure is used). Specifically, a link relation is defined between a whole captured image and a partial image, and equivalency of the link relation to the folder structure is reflected in the display screen. The “simultaneous display screen” is, as shown in FIG. 41, a display screen in which three captured images are displayed in the first row and three AF area images are displayed in the second row obtained by dividing the image display area of the liquid crystal monitor 211 into a matrix of two rows and three columns. In this case, the link relation is reflected in the vertical direction of the liquid crystal monitor 211. That is, the “basic layout” described with respect to the generalized image display apparatus 1 is applied to the display screen. In FIGS. 39 and 40, a link relation exists between images displayed in almost the same position.

The “normal display screen”, “AF area display screen”, and “simultaneously display screen” can be sequentially switched by the display switching button 215a.

By such a display method, the user can recognize a list of only AF areas (focus portions) and therefore can easily confirm whether a proper image has been obtained or not. In addition, the user can check the details of an AF area while checking the whole image.

Others

In the second preferred embodiment, the AF area information is used as link information. However, another information for specifying a part of an image may be also used as link information. Further, the link information may be changed for each image. Alternately, the user is allowed to designate the link information to each image. An image may be reproduced and displayed not necessarily on an image display apparatus built in a digital camera but on another computer system.

While the invention has been shown and described in detail, the foregoing description is in all aspects illustrative and not restrictive. It is therefore understood that numerous modifications and variations can be devised without departing from the scope of the invention.

What is claimed is:

1. An image display apparatus comprising:
a storing part for storing an image group and information of a link relation, said image group being classified according to predetermined criteria, and said link relation defining the relation between a plurality of images included in said image group;
a reading part for reading a group of linked images from said image group and said link relation, said link relation being defined for said group of linked images;
a display part for displaying said group of linked images; and
a layout determining part for determining a display layout of said group of linked images on said display part on the basis of said link relation.

2. The image display apparatus according to claim 1, wherein said link relation is defined for images belonging to different categories in said criteria.

3. The image display apparatus according to claim 2, further comprising:
a no-link detecting part for specifying a no-link image, to said no-link image, a link image having a link relation not being linked; and
a generating part for generating an alternative image, said alternative image indicating absence of a link relation, wherein said display part displays said no-link image and said alternative image in a layout similar to the layout of said group of linked images.

4. The image display apparatus according to claim 3, further comprising:
an image capturing part for capturing an image of a subject;
an instructing part for giving an instruction to capture an image by said image capturing unit; and
a switching part for switching an operation mode between a reproduction mode and an image capturing mode, said reproduction mode for displaying an image stored in said storing part onto said display part, and said image capturing mode for capturing an image by using said image capturing part, wherein
when an image capturing instruction is given by said instruction part, a link relation is defined between a captured image and said no-link image,
said image capturing instruction being given in a state where said alternative image is displayed on said display part in said reproduction mode or being given subsequent to a shift from said reproduction mode to said image capturing mode by said switching part.

5. The image display apparatus according to claim 1, wherein
said link relation is defined between a whole image and a partial image of a specific image.

6. The image display apparatus according to claim 5, wherein
said partial image is a part used for focusing operation at the time of capturing said image.

7. The image display apparatus according to claim 1, further comprising:
a change instructing part for giving an instruction to change said group of linked images displayed on said display part, wherein
the group of linked images displayed on said display part is updated from a first group of linked images to a second group of linked images in response to said change instruction,
said first group of linked images is associated on the basis of a first link relation or a set of link relations, and
said second group of linked images is associated on the basis of a second link relation or a set of link relations.

8. The image display apparatus according to claim 7, wherein
said first link relation is a link relation defining a relation between a first image and a second image, and
said second link relation is a link relation defining a relation between said first image and a third image.

9. The image display apparatus according to claim 7, wherein
said first link relation is a link relation defining a relation between a fourth image and a fifth image,
said second link relation is a link relation defining a relation between a sixth image and a seventh image,
said fourth image and said sixth image belong to the same category, and
said fifth image and said seventh image belong to the same category.

10. The image display apparatus according to claim 7, wherein
a sequence relation is defined for said group of linked images, and
said updating is performed on the basis of said sequence relation.

11. The image display apparatus according to claim 10, further comprising:
a plurality of change instructing parts, said plurality of change instructing parts corresponding to a forward direction and a reverse direction in said sequence relation, wherein
information indicative of a valid change instructing part out of said plurality of change instructing parts is displayed on said display part.

12. The image display apparatus according to claim 1, wherein
said link relation is independent of said criteria.

13. The image display apparatus according to claim 1, wherein
information of said link relation is provided with an image.

14. The image display apparatus according to claim 1, wherein
information of said link relation is provided separately from an image.

15. The image display apparatus according to claim 1, wherein
said image group is stored in a hierarchical folder structure in said storing part, and
said classification is performed on the basis of a folder in said folder structure.

16. The image display apparatus according to claim 1, wherein
said layout determining part determines said layout on the basis of symmetry of said link relation.

17. The image display apparatus according to claim 1, wherein
said layout determining part determines said layout on the basis of a plurality of link relations.

18. The image display apparatus according to claim 1, wherein
said link relation is defined between a guide image and an image captured by guided image capturing,
said guide image is a sample of a composition, and
said image captured by the guided image capturing is captured by using said guide image as a sample.

19. An image display apparatus comprising:
a storing part for storing an image group and information of a link relation, said image group being classified according to predetermined criteria, and said link relation defining the relation between a plurality of images included in said image group;
a reading part for reading a group of linked images from said image group and said link relation, said link relation being defined for said group of linked images;
a display part for displaying said group of linked images;
a dividing part for dividing an image display area into a plurality of areas, said image display area being provided in said display part; and
a display position determining part for determining an area in which an image is to be displayed on the basis of said link relation,
said image being an image included in said group of linked images and
said area being one of said plurality of areas.

20. The image display apparatus according to claim 19, wherein
said image display area is a rectangle, and
said dividing part divides said image display area into a matrix.

21. A computer program product for causing a computer to execute processing including the following steps of:
storing information of an image group and a link relation, said image group being classified according to predetermined criteria, and said link relation defining the relation between a plurality of images included in said image group;
reading a group of linked images from said image group and said link relation, said link relation being defined for said group of linked images;
displaying said group of linked images; and
determining a display layout of said group of linked images on said display part on the basis of said link relation.
